(19) United States
(12) Patent Application Publication
(10) Pub. No.: US 2025/0303348 A1
(43) Pub. Date: Oct. 2, 2025

(54) CARBON DIOXIDE RECOVERY APPARATUS AND CARBON DIOXIDE RECOVERY METHOD

(71) Applicant: HONDA MOTOR CO., LTD., Tokyo (JP)

(72) Inventors: Subaru MATSUMOTO, Saitama (JP); Hibiki KIMURA, Saitama (JP)

(21) Appl. No.: 19/063,339

(22) Filed: Feb. 26, 2025

(30) Foreign Application Priority Data
Mar. 28, 2024 (JP) 2024-052997

(51) Int. Cl. B01D 53/04; B01D 53/047; B01D 53/34; B01D 53/62

(52) U.S. Cl. CPC B01D 53/0462; B01D 53/0438; B01D 53/0476; B01D 53/346; B01D 53/62; B01D 2257/504

(57) ABSTRACT

Provided are an energy-efficiency carbon dioxide recovery apparatus and a carbon dioxide recovery method utilizing cooling of a high-temperature gas containing carbon dioxide and superheated water vapor. A carbon dioxide recovery apparatus includes a reactor, a heat exchanger, a first intercooler that cools a gas containing carbon dioxide desorbed in a desorption process and water vapor, and a second intercooler that cools a gas containing carbon dioxide desorbed in the desorption process and water vapor, and the heat exchanger includes a heat-pump heat generator, a heat source high-temperature water circuit, and a heat source low-temperature water circuit in which the cold water used to cool the reactor is cooled by the heat generator and waste heat is recovered from the second intercooler by using the cold water.

This application is based on and claims the benefit of priority from Japanese Patent Application No. 2024-052997, filed on 28 Mar. 2024, the content of which is incorporated herein by reference.

### BACKGROUND OF THE INVENTION

### Field of the Invention

The present invention relates to a carbon dioxide recovery apparatus and a carbon dioxide recovery method.

### Related Art

A carbon dioxide recovery apparatus has been conventionally known in which a gas such as air containing carbon dioxide is drawn into a reactor that holds an adsorbent to adsorb the carbon dioxide onto the adsorbent, and the adsorbed carbon dioxide is desorbed by heating the adsorbent under reduced pressure to recovery the carbon dioxide. This kind of technology is disclosed in, for example, Japanese Unexamined Patent Application, Publication No. 2022-152387. Japanese Unexamined Patent Application, Publication No. 2022-152387 discloses an internal-combustion-engine CO₂ separation device that is provided in an exhaust system of an internal combustion engine and separates CO₂ from an exhaust gas.
Patent Document 1: Japanese Unexamined Patent Application, Publication No. 2022-152387

### SUMMARY OF THE INVENTION

In a desorption process of a carbon dioxide recovery apparatus, a high-temperature gas containing carbon dioxide and superheated water vapor is cooled by a cooler such as an intercooler to perform gas-liquid separation. Since high-temperature superheated water vapor contains high thermal energy, a low-temperature thermal medium for performing sufficient cooling and a configuration for supplying the thermal medium are needed. On the other hand, a reactor that holds an adsorbent needs to be supplied with heat by a heat generator such as a heat pump, and cooling of superheated water vapor can be considered an energy loss. The conventional technology has room for improvement in terms of improving energy efficiency.

The present invention is intended to provide an energy-efficiency carbon dioxide recovery apparatus and a carbon dioxide recovery method utilizing cooling of a high-temperature gas containing carbon dioxide and superheated water vapor.

(1) The present invention is a carbon dioxide recovery apparatus (for example, carbon dioxide recovery apparatus 1 to be described later) including: a reactor (for example, reactor 11 to be described later) that includes an adsorbent (for example, adsorbent 12 to be described later) inside and executes an adsorption process in which a gas containing carbon dioxide is drawn toward the adsorbent to adsorb the carbon dioxide and a desorption process in which the adsorbent is heated under surrounding reduced pressure to desorb the carbon dioxide from the adsorbent; a heat exchanger (for example, heat exchanger 70 to be described later) capable of executing heating that supplies a heating thermal medium (for example, hot water to be described later) to the reactor and cooling that supplies a cooling thermal medium (for example, cold water to be described later) to the reactor; a first cooler (for example, first intercooler 51 to be described later) that cools a gas containing the carbon dioxide desorbed in the desorption process and water vapor; and a second cooler (for example, second intercooler 52 to be described later) that cools a gas containing the carbon dioxide desorbed in the desorption process and water vapor, and the heat exchanger includes a heat-pump heat generator (for example, heat generator 81 to be described later) that heats the heating thermal medium and cools the cooling thermal medium, a heat source high-temperature water circuit (for example, heat source high-temperature water circuit 85 to be described later) in which the heating thermal medium used to heat the reactor is heated by the heat generator and waste heat is recovered from the first cooler by using the heating thermal medium, and a heat source low-temperature water circuit (for example, heat source low-temperature water circuit 86 to be described later) in which the cooling thermal medium used to cool the reactor is cooled by the heat generator and waste heat is recovered from the second cooler by using the cooling thermal medium.

(2) The carbon dioxide recovery apparatus described above in (1) further includes a control device that controls a flow rate of the heating thermal medium flowing to the first cooler, and a flow rate of the cooling thermal medium flowing to the second cooler (for example, control device 90 to be described later) based on a balance between a heating load applied to the heat source high-temperature water circuit and a recovered waste heat amount in the heat source low-temperature water circuit.

(3) In the carbon dioxide recovery apparatus described above in (2), the control device may calculate recovery amounts of the carbon dioxide and water based on environmental conditions of external air, calculate the heating load based on predicted recovery amounts of the carbon dioxide and the water, calculate the recovered waste heat amount of the heat source low-temperature water circuit based on a cooling demand of a target instrument that executes the adsorption process or the desorption process or a cooling demand of the reactor, predict a heating COP of the heat generator during operation based on temperatures of the heating thermal medium and the cooling thermal medium that are supplied to the heat generator, and the heating load, and select a first heat recovery mode (for example, cascade heat recovery mode to be described later) in which waste heat is recovered in each of the first cooler and the second cooler in a case where the heating COP can be improved, or select a second heat recovery mode (for example, to be described later, low-temperature side heat recovery mode) in which waste heat is recovered in the second cooler in a case where the heating COP cannot be improved even by selecting the first heat recovery mode.

(4) In the carbon dioxide recovery apparatus described above in (3), in the first heat recovery mode, an amount and temperature of heat recovery in the heat source high-temperature water circuit may control at least one selected from the flow rate of the heating thermal medium flowing to the first cooler and the flow rate of the cooling thermal medium flowing to the second cooler so that the heating COP of the heat generator is maximized.

(5) In the carbon dioxide recovery apparatus described above in any one of (1) to (3), the second cooler may cool a gas cooled by the first cooler.

(6) In the carbon dioxide recovery apparatus described above in any one of (1) to (3), the heat source high-temperature water circuit may include a heating thermal medium tank (for example, hot water tank 83 to be described later) that accumulates the heating thermal medium, a heating thermal medium side heat source supply line (for example, hot water side heat source supply line 221 to be described later) that transfers the heating thermal medium from the heating thermal medium tank to the heat generator, and a heating thermal medium side heat source return line (for example, hot water side heat source return line 222 to be described later) that returns the heating thermal medium from the heat generator to the heating thermal medium tank, and the first cooler may be disposed in a heating thermal medium supply line (for example, hot water supply line 112a to be described later) that supplies the heating thermal medium from the heating thermal medium tank to the reactor or in the heating thermal medium side heat source return line (for example, hot water side heat source return line 222 to be described later).

(7) In the carbon dioxide recovery apparatus described above in any one of (1) to (3), the heat source low-temperature water circuit may include a cooling thermal medium tank (cold water tank 82) that accumulates the heating thermal medium, a cooling thermal medium side heat source supply line (for example, cold water side heat source supply line 121 to be described later) that transfers the cooling thermal medium from the cooling thermal medium tank to the heat generator, a cooling thermal medium side heat source return line (for example, cold water side heat source return line 122 to be described later) that returns the cooling thermal medium from the heat generator to the cooling thermal medium tank, and an instrument heat recovery circuit (for example, instrument heat recovery circuit 87 to be described later) that branches from the heat source low-temperature water circuit, is connected to an inflow side of the heat source low-temperature water circuit to the heat generator through a target instrument for performing the adsorption process or the desorption process, and returns the cooling thermal medium used to recover waste heat from the target instrument to the heat generator, and the second cooler may be disposed in a cooling thermal medium return line (for example, cold water return line 111b to be described later) that returns the cooling thermal medium from the reactor to the cooling thermal medium tank or may be disposed as the target instrument in the instrument heat recovery circuit.

(8) In the carbon dioxide recovery apparatus described above in (7), the target instrument may be a pump (for example, vacuum pump 62 or carbon dioxide recovery pump 63 to be described later) that applies suction force to the reactor, and the second cooler may be disposed downstream of the pump in the instrument heat recovery circuit.

(9) The present invention is also a carbon dioxide recovery method using a carbon dioxide recovery apparatus (for example, carbon dioxide recovery apparatus 1 to be described later) including: a reactor (for example, reactor 11 to be described later) that includes an adsorbent (for example, adsorbent 12 to be described later) inside and executes an adsorption process in which a gas containing carbon dioxide is drawn toward the adsorbent to adsorb the carbon dioxide and a desorption process in which the adsorbent is heated under surrounding reduced pressure to desorb the carbon dioxide from the adsorbent; a heat exchanger (for example, heat exchanger 70 to be described later) capable of executing heating that supplies a heating thermal medium (for example, hot water to be described later) to the reactor and cooling that supplies a cooling thermal medium (for example, cold water to be described later) to the reactor; a first cooler (for example, first intercooler 51 to be described later) that cools a gas containing the carbon dioxide desorbed in the desorption process and water vapor; and a second cooler (for example, second intercooler 52 to be described later) that cools a gas containing the carbon dioxide desorbed in the desorption process and water vapor, and the carbon dioxide recovery method includes: heating the heating thermal medium and cooling the cooling thermal medium by a heat-pump heat generator (for example, heat generator 81 to be described later) included in the heat exchanger; heating the heating thermal medium used to heat the reactor by the heat generator and recovering waste heat from the first cooler by using the heating thermal medium; and cooling the cooling thermal medium used to cool the reactor by the heat generator and recovering waste heat from the second cooler by using the cooling thermal medium.

According to the present invention, a configuration that can immediately start activation even when external air is at low temperature can be provided to a carbon dioxide recovery apparatus and a carbon dioxide recovery method that perform a desorption process and an adsorption process through heat control of a heat-pump heat generator.

### BRIEF DESCRIPTION OF THE DRAWINGS

FIG. 1 is a schematic diagram illustrating a configuration related to gas flow in a carbon dioxide recovery apparatus according to an embodiment of the present invention;

FIG. 2 is a schematic diagram illustrating a configuration related to liquid flow in the carbon dioxide recovery apparatus according to the present embodiment;

FIG. 3 is a schematic diagram illustrating a configuration related to gas flow in a reactor of the carbon dioxide recovery apparatus according to the present embodiment;

FIG. 4 is a schematic diagram illustrating a configuration related to liquid flow in the reactor of the carbon dioxide recovery apparatus according to the present embodiment;

FIG. 5 is a schematic diagram illustrating the configuration of a heat source circuit of the carbon dioxide recovery apparatus according to the present embodiment;

FIG. 6 is a schematic diagram of a cooling mechanism for a high-temperature gas by using a first intercooler and a second intercooler;

FIG. 7 is a graph illustrating the relation between the temperature of superheated water vapor of a high-temperature gas and the temperature of hot water, which changes through cooling by using the first intercooler;

FIG. 8 is a graph illustrating the relation between the temperature of supercooled liquid and the temperature of cold water, which changes through cooling by using the second intercooler;

FIG. 9 is a bar graph illustrating the composition ratio of the heating load of a heat source high-temperature water circuit and the composition ratio of waste heat recovery of a heat source low-temperature water circuit;

FIG. 10 is a graph illustrating the relation between the heat exchange amount and heating COP of a heat generator;

FIG. 11 is a flowchart illustrating an example of operation control processing of the carbon dioxide recovery apparatus according to the present embodiment; and

FIG. 12 is a schematic diagram of a cooling mechanism for a high-temperature gas by using the first intercooler and the second intercooler according to a modification.

### DETAILED DESCRIPTION OF THE INVENTION

An embodiment of the present invention will be described below with reference to the accompanying drawings.

### <Entire Configuration>

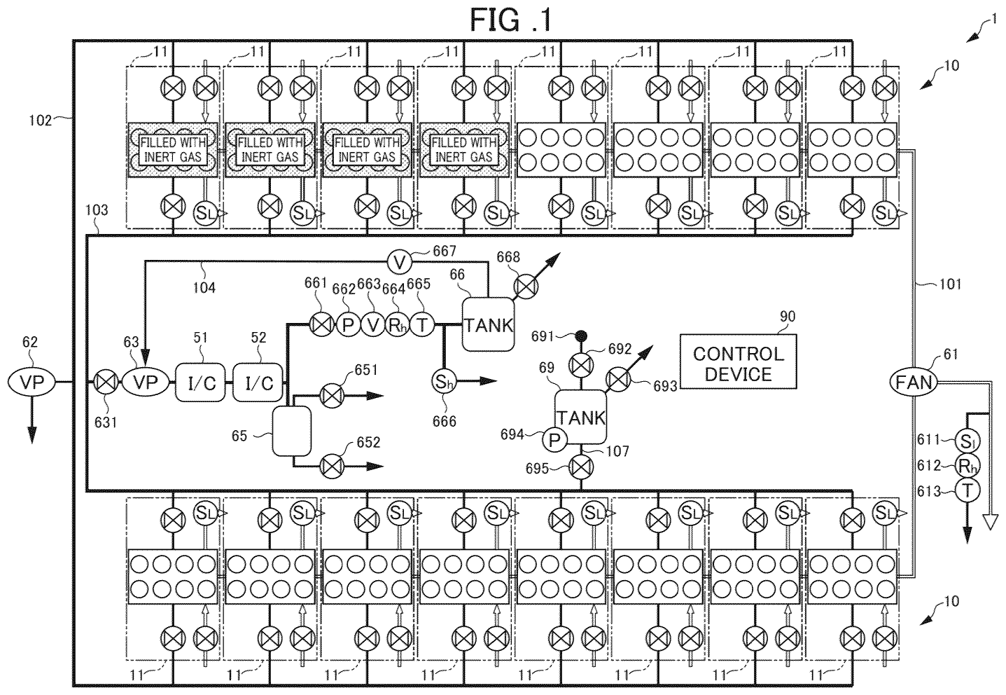

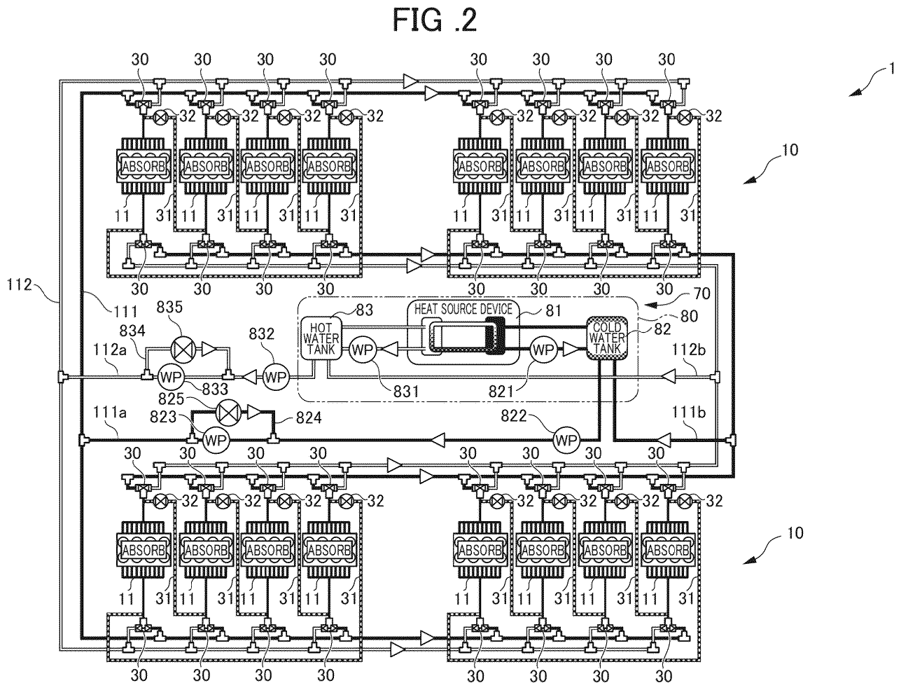

FIG. 1 is a schematic diagram illustrating a configuration related to gas flow in a carbon dioxide recovery apparatus 1 according to the embodiment of the present invention. FIG. 2 is a schematic diagram illustrating a configuration related to liquid flow in the carbon dioxide recovery apparatus 1 according to the present embodiment. Illustration of the configuration related to liquid flow in the carbon dioxide recovery apparatus 1 is omitted in FIG. 1, and illustration of the configuration related to gas flow in the carbon dioxide recovery apparatus 1 is omitted in FIG. 2.

The carbon dioxide recovery apparatus 1 according to the present embodiment is applied to, for example, the Direct Air Capture technology (DAC), which recovers carbon dioxide in atmospheric air to lower the carbon dioxide concentration in the atmospheric air. Carbon dioxide recovered by the carbon dioxide recovery apparatus 1 is stored underground or reused as fuel or material.

As illustrated in FIGS. 1 and 2, the carbon dioxide recovery apparatus 1 according to the present embodiment includes a reactor unit 10, a fan 61, a vacuum pump 62, a carbon dioxide recovery pump 63, a first intercooler 51, a second intercooler 52, a separator 65, a carbon dioxide tank 66, an inert gas tank 69, a heat exchanger 70, and a control device 90.

As illustrated in FIG. 1, the carbon dioxide recovery apparatus 1 includes an adsorption line 101, a vacuum line 102, a carbon dioxide line 103, a circulation line 104, and an inert gas supply line 107 as gas flow paths.

The reactor unit 10 has a configuration in which a plurality of reactors 11 that adsorb carbon dioxide are disposed in parallel. In the present embodiment, 16 reactors 11 in total are disposed in a pair of right and left reactor units 10.

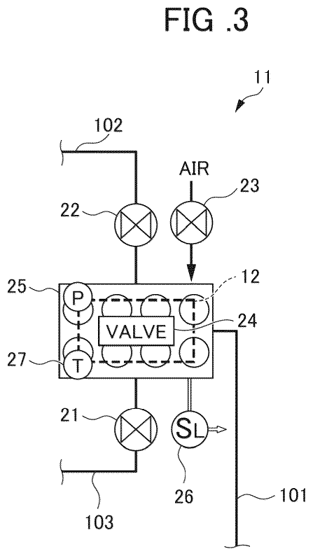

FIG. 3 is a schematic diagram illustrating a configuration related to gas flow in each reactor 11 of the carbon dioxide recovery apparatus 1 according to the present embodiment. The reactor 11 is a carbon dioxide recovery reactor including an adsorbent 12, a first valve 21, a second valve 22, a third valve 23, a fourth valve 24, a pressure sensor 25, a carbon dioxide sensor 26, and a temperature sensor 27.

The adsorbent 12 is disposed inside the reactor 11 to adsorb carbon dioxide. The adsorbent 12 is a particulate member and has characteristics that it adsorbs carbon dioxide at low temperature (for example, −30° C. to 50° C.) and desorbs (releases) carbon dioxide at high temperature (for example, 50° C. to 110° C.) and low carbon dioxide concentration in surroundings. Such an adsorbent 12 is, for example, a solid amine carbon dioxide adsorbent composed of a porous material such as silica onto which amines are supported.

The first valve 21 is an on-off valve disposed at a connection part of the carbon dioxide line 103, which recovers carbon dioxide, to the reactor 11. The carbon dioxide recovery pump 63 is disposed in the carbon dioxide line 103. The second valve 22 is an on-off valve disposed at a connection part of the vacuum line 102, in which the vacuum pump 62 is disposed, to the reactor 11. The third valve 23 is an on-off valve disposed at an inlet through which atmospheric air and the like are taken into the reactor 11. The fourth valve 24 is an on-off valve disposed at a connection part of the adsorption line 101 to the reactor 11.

Opening and closing of the first valve 21, the second valve 22, the third valve 23, and the fourth valve 24 is controlled by the control device 90. The first valve 21, the second valve 22, the third valve 23, and the fourth valve 24 are constituted by, for example, normally-open butterfly valves.

The pressure sensor 25 measures the internal pressure of the reactor 11. The carbon dioxide sensor 26 measures the internal carbon dioxide concentration of the reactor 11. The temperature sensor 27 measures the temperature of the adsorbent 12. Measurement information of the pressure sensor 25, the carbon dioxide sensor 26, and the temperature sensor 27 are transmitted to the control device 90.

The adsorption line 101 and the fan 61 will be described below with reference to FIG. 1 again. The adsorption line 101 is branch-connected to each reactor 11. The fan 61 is disposed at a convergence part of branch parts of the adsorption line 101. When driven, the fan 61 generates gas flow from “intake” to “exhaust” in each reactor 11 through the adsorption line 101. Accordingly, atmospheric air is supplied into each reactor 11. A carbon dioxide concentration sensor 611, a humidity sensor 612, and a temperature sensor 613 are disposed at a part of the adsorption line 101, where gas is exhausted, to measure carbon dioxide exhausted from the adsorption line 101, humidity, and temperature. Measurement information of the carbon dioxide concentration sensor 611, the humidity sensor 612, and the temperature sensor 613 is transmitted to the control device 90.

The vacuum line 102 is branch-connected to each reactor 11. The vacuum pump 62 is disposed at a convergence part of branch parts of the vacuum line 102. When driven, the vacuum pump 62 draws in gas from inside each reactor 11 through the vacuum line 102 to bring the inside of the reactor 11 to a vacuum state or near-vacuum state.

The carbon dioxide line 103 is branch-connected to each reactor 11. The carbon dioxide recovery pump 63, an intercooler 64, the separator 65, and the carbon dioxide tank 66 are disposed at convergence parts of branch parts of the carbon dioxide line 103.

The carbon dioxide recovery pump 63 applies suction force that sends carbon dioxide circulating through the carbon dioxide line 103 to the carbon dioxide tank 66. A one-way valve 631 is disposed upstream of the carbon dioxide recovery pump 63 in the carbon dioxide line 103. This configuration prevents gas from flowing back from the intercooler 64 side to the reactor 11 side.

The first intercooler 51 and the second intercooler 52 are each an intermediate cooler that cools a high-temperature gas (superheated water vapor) containing carbon dioxide, which is recovered from the reactors 11, and performs gas-liquid separation. The first intercooler 51 and the second intercooler 52 are disposed in series. The first intercooler 51 cools a high-temperature gas (for example, 120° C.) so that superheated water vapor included in the high-temperature gas becomes supercooled liquid (for example, 80° C.). The second intercooler 52 further cools the supercooled liquid (for example, 80° C.) generated through the cooling by the first intercooler 51 so that the supercooled liquid becomes low-temperature supercooled liquid (for example, 32° C.).

The supercooled liquid subjected to gas-liquid separation through the first intercooler 51 and the second intercooler 52 is recovered in the separator 65. A first valve 651 and a second valve 652 are disposed in the separator 65. The first valve 651 opens and closes a path communicating with a gas phase section of the separator 65. The second valve 652 opens and closes a path communicating with a liquid phase section of the separator 65.

The carbon dioxide tank 66 stores carbon dioxide recovered through the carbon dioxide line 103. A tank valve 661 is disposed upstream of the carbon dioxide tank 66 in the carbon dioxide line 103. Opening and closing of the tank valve 661 is controlled by the control device 90. In addition, various sensors such as a pressure sensor 662, a flow rate sensor 663, a humidity sensor 664, a temperature sensor 665, and a carbon dioxide concentration sensor 666 are disposed between the tank valve 661 and the carbon dioxide tank 66 in the carbon dioxide line 103.

A circulation line 104 that returns ballast in addition to the carbon dioxide line 103 to the carbon dioxide recovery pump 63 is connected to the carbon dioxide tank 66. A flow rate sensor 667 is disposed in the circulation line 104. In addition, a pressure relief valve 668 that releases pressure when it exceeds a predetermined pressure is disposed in the carbon dioxide tank 66.

The inert gas tank 69 will be described next. The inert gas tank 69 stores N₂ as inert gas supplied from a N₂ gas tank 691 at a certain pressure or higher (for example, 980 kPa). A gas tank valve 692 is disposed between the inert gas tank 69 and the N₂ gas tank 691. In addition, a pressure relief valve 693 that releases pressure when the pressure becomes equal to or higher than a predetermined pressure is disposed at the inert gas tank 69. A pressure sensor 694 is disposed inside the inert gas tank 69. Pressure information measured by the pressure sensor 694 is transmitted to the control device 90.

The inert gas tank 69 is connected to the carbon dioxide line 103 through the inert gas supply line 107. An inert gas valve 695 is disposed in the inert gas supply line 107. Opening and closing of the inert gas valve 695 is controlled by the control device 90.

The heat exchanger 70 will be described below with reference to FIG. 2. The heat exchanger 70 supplies thermal energy for heating each reactor 11 of the reactor unit 10 to a predetermined temperature when the reactor 11 performs a desorption process. In addition, the heat exchanger 70 recovers unnecessary thermal energy when each reactor 11 performs an adsorption process.

The heat exchanger 70 according to the present embodiment includes a heat source circuit 80, a cold water line 111, a hot water line 112, three-way valves 30, bypass paths 31, and bypass valves 32.

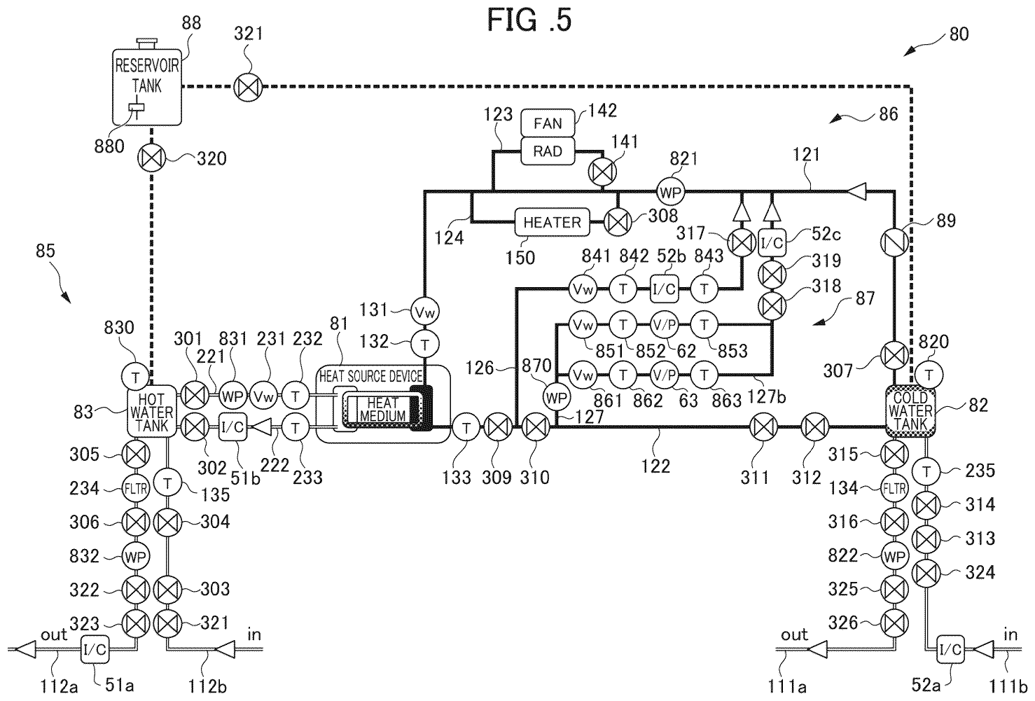

The heat source circuit 80 includes a heat source device 81, a cold water tank 82, and a hot water tank 83 as main components and performs heat exchange between a cooling thermal medium flowing through the cold water line 111 and a heating thermal medium flowing through the hot water line 112. With heat transfer that occurs in the heat source circuit 80, the thermal medium flowing through the cold water line 111 is cooled and the thermal medium flowing through the hot water line 112 is heated. A thermal medium is, for example, liquid such as water. A detailed configuration of the heat source circuit 80 will be described later with reference to FIG. 5.

The cold water line 111 is a pipe through which cold water as the cooling thermal medium flows. The cold water line 111 is branch-connected to the upstream and downstream sides of each reactor 11 to connect the cold water tank 82 and the reactor 11. In the cold water line 111, a line connected to the upstream side of the reactors 11 is referred to as a cold water supply line 111a, and a line connected to the downstream side of the reactors 11 is referred to as a cold water return line 111b.

The cold water supply line 111a is connected in parallel to the reactors 11 and can perform cold water supply to the reactors 11 in parallel. A first cold water circulation water pump 822 and a second cold water circulation water pump 823 are disposed in the cold water supply line 111a. The first cold water circulation water pump 822 and the second cold water circulation water pump 823 are, for example, cascade pumps.

In addition, a circulation line 824 that returns from the downstream side to the upstream side of the second cold water circulation water pump 823 is disposed in the cold water supply line 111a. A safety valve 825 is disposed in the circulation line 824. The safety valve 825 relieves pressure to prevent pressure increase when the inside of a system of the second cold water circulation water pump 823 and the cold water line 111 reaches a certain pressure or higher. Since the safety valve 825, which relieves pressure when pressure anomaly occurs in the system of the cold water line 111, is disposed in parallel to the second cold water circulation water pump 823, it is possible to achieve both high flow circulation and secure operation of the second cold water circulation water pump 823.

The cold water return line 111b as well is connected in parallel to the reactors 11 and can perform cold water recovery from the reactors 11 after cooling completion in parallel.

The hot water line 112 is a pipe through which hot water as the heating thermal medium flows. The hot water line 112 is branch-connected to the upstream and downstream sides of each reactor 11 to connect the hot water tank 83 and the reactor 11. In the hot water line 112, a line connected to the upstream side of the reactors 11 is referred to as a hot water supply line 112a, and a line connected to the downstream side of the reactors 11 is referred to as a hot water return line 112b.

The hot water supply line 112a is connected in parallel to the reactors 11 and can perform hot water supply to the reactors 11 in parallel. A first hot water circulation water pump 832 and a second hot water circulation water pump 833 are disposed in the hot water supply line 112a. The first hot water circulation water pump 832 and the second hot water circulation water pump 833 are, for example, cascade pumps. When cascade pumps that generate a large amount of heat when driven are used, it is possible to further heat a thermal medium passing through the first hot water circulation water pump 832 and the second hot water circulation water pump 833.

In addition, a circulation line 834 that returns from the downstream side to the upstream side of the second hot water circulation water pump 833 is disposed in the hot water supply line 112a. A safety valve 835 is disposed in the circulation line 834. The safety valve 835 relieves pressure to prevent pressure increase when the inside of a system of the second hot water circulation water pump 833 and the hot water line 112 reaches a certain pressure or higher. Since the safety valve 835, which relieves pressure when pressure anomaly occurs in the system of the hot water line 112, is disposed in parallel to the second hot water circulation water pump 833, it is possible to achieve both high flow circulation and secure operation of the second hot water circulation water pump 833.

The hot water return line 112b as well is connected in parallel to the reactors 11 and can perform hot water recovery from the reactors 11 after heating completion in parallel.

The three-way valves 30 are connected to the cold water line 111, the hot water line 112, and the reactors 11. The three-way valves 30 are disposed on the upstream and downstream sides of each reactor 11. By flow path switching, the three-way valves 30 can select a cold water connection state in which the cold water line 111 is connected to the reactors 11, a hot water connection state in which the hot water line 112 is connected to the reactors 11, and a cutoff state in which connection of the cold water line 111 and the hot water line 112 to the reactors 11 is cut off.

The flow path switching of the three-way valves 30 is controlled by the control device 90. A thermal medium is introduced to each reactor 11 through a three-way valve 30 disposed on the upstream side and is returned to the heat source device 81 side through a three-way valve 30 disposed on the downstream side.

The bypass paths 31 are flow paths that enable thermal medium movement among the reactors 11. Each bypass path 31 connects two reactors 11. The reactors 11 connected by each bypass paths 31 may be adjacent reactors or may be reactors 11 that are not adjacent but separated.

The bypass valves 32 are disposed in the bypass paths 31. The bypass valves 32 are disposed in the respective bypass paths 31. Opening and closing of each bypass valve 32 is controlled by the control device 90.

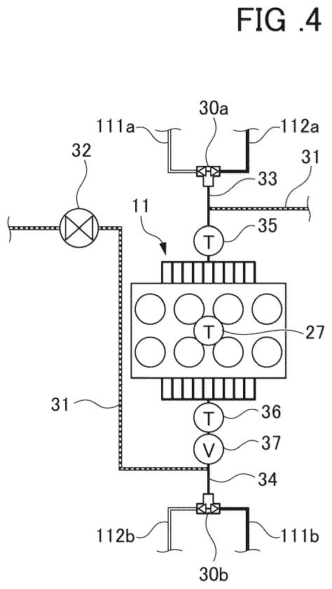

FIG. 4 is a schematic diagram illustrating a configuration related to liquid flow in each reactor 11 of the carbon dioxide recovery apparatus 1 according to the present embodiment. In the following description, a three-way valve 30 disposed upstream of the reactor 11 is referred to as a three-way valve 30a, and a three-way valve 30 disposed downstream of the reactor 11 is referred to as a three-way valve 30b.

As illustrated in FIG. 4, the reactor 11 includes an inlet-side flow path 33 connected to an inlet through which a thermal medium flows in, and an outlet-side flow path 34 connected to an outlet through which the thermal medium flows out. A bypass path 31 is connected to the outlet-side flow path 34 of the reactor 11 and also connected to the inlet-side flow path 33 of another reactor 11.

The three-way valve 30a is disposed at an upstream end part of the inlet-side flow path 33, and the three-way valve 30b is disposed at a downstream end part of the outlet-side flow path 34. In the hot water connection state, the three-way valve 30a is connected to the hot water supply line 112a, and the three-way valve 30b is connected to the hot water return line 112b. In the cold water connection state, the three-way valve 30a is connected to the cold water supply line 111a, and the three-way valve 30b is connected to the cold water return line 111b.

The three-way valve 30a and the three-way valve 30b can adjust flow rate. With this flow rate adjustment function, the flow rate of hot water can be adjusted in the hot water connection state, and the flow rate of cold water can be adjusted in the cold water connection state.

A temperature sensor 35 is disposed in the inlet-side flow path 33. A temperature sensor 36 and a flow rate sensor 37 are disposed in the outlet-side flow path 34. Measurement information of the temperature sensor 35, the temperature sensor 36, and the flow rate sensor 37 is transmitted to the control device 90.

The control device 90 will be described next. The control device 90 controls operation of each component of the carbon dioxide recovery apparatus 1. The control device 90 controls operations such as drive and stop of devices used for carbon dioxide adsorption and desorption. The control device 90 selectively controls the timing of thermal medium supply to each reactor 11 for heating and cooling so that the reactors 11 repeat adsorption and desorption in a time-series manner.

The control device 90 controls opening and closing of the first valve 21, the second valve 22, the third valve 23, and the fourth valve 24 included in each reactor 11 and controls opening and closing of each bypass valve 32. In addition, the control device 90 controls drive of the fan 61, the vacuum pump 62, the carbon dioxide recovery pump 63, the first cold water circulation water pump 822, the second cold water circulation water pump 823, the first hot water circulation water pump 832, the second hot water circulation water pump 833, and the like, and controls opening and closing of the safety valve 825 and the safety valve 835.

The control device 90 is, for example, a computer including a central processing unit (CPU), a read only memory (ROM), a random access memory (RAM), and the like. The control device 90 may be configured by one computer or a plurality of computers. Alternatively, the control device 90 may be configured by utilizing an electric circuit such as a relay.

### <Carbon Dioxide Recovery>

Carbon dioxide recovery control by the control device 90 will be described next. The carbon dioxide recovery apparatus 1 removes and recovers carbon dioxide in atmospheric air by alternately performing an adsorption process in which carbon dioxide in a drawn gas such as atmospheric air is adsorbed onto the adsorbent 12 in each reactor 11 and a desorption process in which the carbon dioxide adsorbed onto the adsorbent 12 is desorbed, and storing the desorbed carbon dioxide in the carbon dioxide tank 66.

The adsorption process is a process in which carbon dioxide is adsorbed onto the adsorbent 12 in each reactor 11. In the adsorption process, the third valve 23 and the fourth valve 24 of the reactor 11 are opened and the first valve 21 and the second valve 22 thereof are closed. Along with the valve opening and closing control, the three-way valve 30a and the three-way valve 30b are controlled to the cold water connection state by the heat exchanger 70, and cold water flows inside the reactor 11 and cools the adsorbent 12 in the reactor 11. The fan 61 is driven, gas flow from upstream to downstream occurs, and a gas containing carbon dioxide (for example, atmospheric air) is drawn in through the third valve 23. The drawn gas passes through the adsorbent 12 in the reactor 11. In this process, the inside of the reactor 11 is at room temperature (25° C.) through cooling by cold water, and carbon dioxide in the gas is adsorbed onto the adsorbent 12. Gasses other than carbon dioxide, such as nitrogen and oxygen are exhausted to the outside of the carbon dioxide recovery apparatus 1 through the fourth valve 24 and the adsorption line 101.

The desorption process is a process in which carbon dioxide on the adsorbent 12 in each reactor 11 is desorbed. In the desorption process, the first valve 21, the third valve 23, and the fourth valve 24 of the reactor 11 are closed and the second valve 22 thereof is opened. The vacuum pump 62 operates to draw in gas from the inside of the reactor 11, thereby bringing the inside to a vacuum state or near-vacuum state through depressurization. Along with the valve opening and closing control, the three-way valve 30a and the three-way valve 30b are controlled to the hot water connection state by the heat exchanger 70, and hot water flows through the reactor 11 and supplies thermal energy, thereby increasing the temperature of the adsorbent 12 in the reactor 11. Through the temperature increase control of the adsorbent 12, the adsorbent 12 is heated to a predetermined temperature (for example, 80° C.) that is sufficient for the desorption process, and carbon dioxide adsorbed onto the adsorbent 12 is desorbed. Subsequently, the second valve 22, the third valve 23, and the fourth valve 24 are closed and the first valve 21 is opened, and then the carbon dioxide recovery pump 63 is driven to store the desorbed carbon dioxide in the carbon dioxide tank 66 through the carbon dioxide line 103. In the present embodiment, processes are controlled so that, among the 16 reactors 11, 12 reactors 11 execute the adsorption process and the remaining four reactors perform the desorption process.

### <Heat Source Circuit>

A detailed configuration of the heat source circuit 80 will be described next with reference to FIG. 5. FIG. 5 is a schematic diagram illustrating the configuration of the heat source circuit 80 of the carbon dioxide recovery apparatus 1 according to the present embodiment.

As illustrated in FIG. 5, the heat source circuit 80 according to the present embodiment includes the heat generator 81, a heat source high-temperature water circuit 85 including the hot water tank 83, a heat source low-temperature water circuit 86 including the cold water tank 82, and a reservoir tank 88.

The heat generator 81 cools a thermal medium introduced from the cold water tank 82 and heats a thermal medium introduced from the hot water tank 83. The heat generator 81 is constituted by a heat pump that transfers heat by utilizing gas compression and expansion.

The heat source high-temperature water circuit 85 circulates hot water between the hot water tank 83 and the heat generator 81. The heat source high-temperature water circuit 85 includes the hot water tank 83, a hot water side heat source supply line 221, and a hot water side heat source return line 222.

The hot water tank 83 is a thermal storage device having a heat-insulating function and capable of accumulating a thermal medium. The capacity of the hot water tank 83 is preferably set to be at least five times the maximum discharge flow rate of a hot water side circulation water pump 831 to be described later. By setting the capacity of the hot water tank 83 to be large relative to the flow rate of the thermal medium, it is possible to suppress water temperature fluctuations of the hot water (thermal medium) during thermal load fluctuations within a predetermined temperature range (for example, +5° C. or less). Accordingly, the hot water tank 83 functions as a thermal load fluctuation buffer.

A temperature sensor 830 for measuring the temperature of the thermal medium is disposed inside the hot water tank 83. The measurement result of the temperature sensor 830 is output to the control device 90. The hot water tank 83 is connected to the heat generator 81 through the hot water side heat source supply line 221 and the hot water side heat source return line 222.

The hot water side heat source supply line 221 is a path through which the thermal medium flows from the hot water tank 83 to the heat generator 81. In the hot water side heat source supply line 221, a valve 301, the hot water side circulation water pump 831, a flow rate sensor 231, and a temperature sensor 232 are disposed sequentially from the upstream side. The hot water side circulation water pump 831 is constituted by, for example, a centrifugal pump and circulates the thermal medium between the hot water tank 83 and the heat generator 81. The flow rate sensor 231 measures the flow rate of the thermal medium flowing into the heat generator 81 and outputs the measurement result to the control device 90. A temperature sensor 233 measures the temperature of the thermal medium flowing into the heat generator 81 and outputs the measurement result to the control device 90.

The hot water side heat source return line 222 is a path through which the thermal medium flows from the heat generator 81 to the hot water tank 83. In the hot water side heat source return line 222, the temperature sensor 233 and a valve 302 are disposed sequentially from the upstream side. The temperature sensor 233 measures the temperature of the hot water flowing out of the heat generator 81 and outputs the measurement result to the control device 90.

The hot water supply line 112a and the hot water return line 112b are connected to the hot water tank 83. A valve 305, a water filter 234, a valve 306, the first hot water circulation water pump 832, a valve 322, and a valve 323 are disposed on the hot water tank 83 side in the hot water supply line 112a. A valve 321, a valve 303, a valve 304, and a temperature sensor 135 are disposed on the hot water tank 83 side in the hot water return line 112b. The inflow temperature of the hot water tank 83 detected by the temperature sensor 135 is output to the control device 90.

The heat source high-temperature water circuit 85 according to the present embodiment performs waste heat recovery for the first intercooler 51 by using the hot water. The first intercooler 51 is disposed at an optional position in the heat source high-temperature water circuit 85. FIG. 5 illustrates a first intercooler 51a disposed downstream of the valve 323 in the hot water supply line 112a, and a first intercooler 51b disposed between the temperature sensor 233 and the valve 302 in the hot water side heat source return line 222. The first intercooler 51a and the first intercooler 51b in FIG. 5 represent disposition position candidates, and the first intercooler 51 may be disposed at the position of either of the first intercooler 51a or the first intercooler 51b.

The heat source low-temperature water circuit 86 will be described next. The heat source low-temperature water circuit 86 circulates cold water between the cold water tank 82 and the heat generator 81. The heat source low-temperature water circuit 86 includes the cold water tank 82, a cold water side heat source supply line 121, and a cold water side heat source return line 122.

The cold water tank 82 is a thermal storage device having a heat-insulating function and capable of accumulating a thermal medium. The capacity of the cold water tank 82 is preferably set to be at least five times the maximum discharge flow rate of a cold water side circulation water pump 821 to be described later. By setting the capacity of the cold water tank 82 to be large relative to the flow rate of the thermal medium, it is possible to suppress water temperature fluctuations of the cold water (thermal medium) during thermal load fluctuations within a predetermined temperature range (for example, +5° C. or less). Accordingly, the cold water tank 82 functions as a thermal load fluctuation buffer.

A temperature sensor 820 for measuring the temperature of the thermal medium is disposed inside the cold water tank 82. The measurement result of the temperature sensor 820 is output to the control device 90. The cold water tank 82 is connected to the heat generator 81 through the cold water side heat source supply line 121 and the cold water side heat source return line 122.

The cold water side heat source supply line 121 is a path through which the thermal medium flows from the cold water tank 82 to the heat generator 81. In the cold water side heat source supply line 121, a valve 307, a check valve 89, the cold water side circulation water pump 821, a flow rate sensor 131, and a temperature sensor 132 are disposed. The check valve 89 disturbs flow of the cold water returning from the heat generator 81 to the cold water tank 82. The cold water side circulation water pump 821 is constituted by, for example, a centrifugal pump and circulates the thermal medium between the cold water tank 82 and the heat generator 81. The flow rate sensor 131 measures the flow rate of the thermal medium flowing into the heat generator 81 and outputs the measurement result to the control device 90. The temperature sensor 132 measures the temperature of the thermal medium flowing into the heat generator 81 and outputs the measurement result to the control device 90.

In addition, a radiator bypass line 123 for cooling the thermal medium and a heater bypass line 124 for heating the thermal medium are connected to the cold water side heat source supply line 121. The radiator bypass line 123 and the heater bypass line 124 are temperature adjustment circuits that adjust the temperature of the thermal medium flowing into the heat generator 81 to an operable temperature during external temperature and thermal load fluctuations.

The radiator bypass line 123 is connected between the cold water side circulation water pump 821 and the flow rate sensor 131 in the cold water side heat source supply line 121. A valve 141 and a radiator fan 142 are disposed in the radiator bypass line 123. The valve 141 can perform opening and closing of a flow path and flow rate adjustment based on a control signal from the control device 90. The radiator fan 142 is a heat-releasing instrument that cools the thermal medium passing through the radiator bypass line 123. The thermal medium cooling by the radiator bypass line 123 is performed mainly during a high-temperature period such as in summer. Through the thermal medium cooling by the radiator bypass line 123, the temperature of the cold water introduced to the heat generator 81 is controlled to be equal to or lower than a threshold value set in advance.

The heater bypass line 124 is connected on the inner side of the radiator bypass line 123 between the cold water side circulation water pump 821 and the flow rate sensor 131 in the cold water side heat source supply line 121. A valve 308 and a heater 150 are disposed in the heater bypass line 124. The heater 150 is driven by a control signal from the control device 90 and a drive signal from a relay and heats the thermal medium flowing through the heater bypass line 124. The thermal medium heating by the heater bypass line 124 is performed mainly during a low-temperature period such as at activation in winter. Through the thermal medium heating by the heater bypass line 124, the temperature of the thermal medium introduced to the heat generator 81 is controlled to be equal to or higher than a threshold value set in advance.

The cold water side heat source return line 122 is a path through which the thermal medium flows from the heat generator 81 to the cold water tank 82. In the cold water side heat source return line 122, a temperature sensor 133, a valve 309, a valve 310, a valve 311, and a valve 312 are disposed sequentially from the upstream side. The temperature sensor 132 measures the temperature of the cold water flowing out of the heat generator 81 and outputs the measurement result to the control device 90.

The cold water supply line 111a and the cold water return line 111b are connected to the cold water tank 82. A valve 315, a water filter 134, a valve 316, the first cold water circulation water pump 822, a valve 325, and a valve 326 are disposed on the cold water tank 82 side in the cold water supply line 111a. A valve 324, a valve 313, a valve 314, and a temperature sensor 235 are disposed on the cold water tank 82 side in the cold water return line 111b. The inflow temperature of the cold water tank 82 detected by the temperature sensor 235 is output to the control device 90.

The heat source low-temperature water circuit 86 according to the present embodiment performs waste heat recovery for the second intercooler 52 by using the cold water. The second intercooler 52 is disposed at an optional position in the heat source low-temperature water circuit 86. FIG. 5 illustrates a second intercooler 52a disposed upstream of the valve 324 in the cold water return line 111b, and a second intercooler 52b and a second intercooler 52c disposed in an instrument heat recovery circuit 87. The second intercooler 52a, the second intercooler 52b, and the second intercooler 52c in FIG. 5 represent disposition position candidates, and the second intercooler 52 may be disposed at the position of any of the second intercooler 52a, the second intercooler 52b, or the second intercooler 52c.

The instrument heat recovery circuit 87 that is a disposition candidate for the second intercooler 52b and the second intercooler 52c will be described next. The instrument heat recovery circuit 87 cools a target instrument such as the vacuum pump 62, the carbon dioxide recovery pump 63, the second intercooler 52b, or/and the second intercooler 52c and increases the temperature of the thermal medium.

The instrument heat recovery circuit 87 is connected in parallel to the heat source low-temperature water circuit 86. The instrument heat recovery circuit 87 according to the present embodiment includes a first instrument heat cooling line 126 that performs heat exchange with the second intercooler 52b, and a second instrument heat cooling line 127 that performs heat exchange with the vacuum pump 62 and the carbon dioxide recovery pump 63.

The first instrument heat cooling line 126 has an upstream end part connected to the cold water side heat source return line 122 and has a downstream end part connected to the cold water side heat source supply line 121. In the present embodiment, the upstream end part of the first instrument heat cooling line 126 is connected to a place between the valve 309 and the valve 310 in the cold water side heat source return line 122. The downstream end part of the first instrument heat cooling line 126 is connected to a place between the valve 307 and the cold water side circulation water pump 821 in the cold water side heat source supply line 121.

The first instrument heat cooling line 126 is connected to the intercooler 64 that generates water vapor condensation heat, and cools the intercooler 64 through the cold water to recover waste heat from the water vapor condensation heat. In the state of being heated through heat exchange with the intercooler 64, the cold water is transferred to the cold water side heat source supply line 121.

In the first instrument heat cooling line 126, a flow rate sensor 841 and a temperature sensor 842 are disposed upstream of the intercooler 64, and a temperature sensor 843 and a valve 317 are disposed downstream of the intercooler 64. The flow rate sensor 841 measures the flow rate of the thermal medium yet to be subjected to heat exchange with the intercooler 64 and outputs the measurement result to the control device 90. The temperature sensor 842 measures the temperature of the thermal medium yet to be subjected to heat exchange with the intercooler 64 and outputs the measurement result to the control device 90. The temperature sensor 843 measures the temperature of the thermal medium subjected to heat exchange with the intercooler 64 and outputs the measurement result to the control device 90.

The second instrument heat cooling line 127 has an upstream end part connected to the cold water side heat source return line 122 and has a downstream end part connected to the cold water side heat source supply line 121. In the present embodiment, the upstream end part of the second instrument heat cooling line 127 is connected to a place between the valve 310 and the valve 311 in the cold water side heat source return line 122. The downstream end part of the second instrument heat cooling line 127 is connected to a place between the valve 307 and the cold water side circulation water pump 821 in the cold water side heat source supply line 121, which is on the upstream side of the connection place of the downstream end part of the first instrument heat cooling line 126.

The second instrument heat cooling line 127 according to the present embodiment also includes a first branch line 127a that cools the vacuum pump 62, and a second branch line 127b that cools the carbon dioxide recovery pump 63.

The first branch line 127a is connected to the vacuum pump 62 and cools the vacuum pump 62 by using the cold water. In the state of being heated through heat exchange with the vacuum pump 62, the thermal medium merges into the second branch line 127b and is transferred to the cold water side heat source supply line 121.

In the first branch line 127a, a flow rate sensor 851 and a temperature sensor 852 are disposed upstream of the vacuum pump 62, and a temperature sensor 853 is disposed downstream of the vacuum pump 62. The flow rate sensor 851 measures the flow rate of the thermal medium yet to be subjected to heat exchange with the vacuum pump 62 and outputs the measurement result to the control device 90. The temperature sensor 852 measures the temperature of the thermal medium yet to be subjected to heat exchange with the vacuum pump 62 and outputs the measurement result to the control device 90. The temperature sensor 853 measures the temperature of the cold water subjected to heat exchange with the vacuum pump 62 and outputs the measurement result to the control device 90.

The second branch line 127b is connected to the carbon dioxide recovery pump 63 and cools the carbon dioxide recovery pump 63 by using the thermal medium. In the state of being heated through heat exchange with the carbon dioxide recovery pump 63, the thermal medium merges into the first branch line 127a and is transferred to the cold water side heat source supply line 121.

In the second branch line 127b, a flow rate sensor 861 and a temperature sensor 862 are disposed upstream of the carbon dioxide recovery pump 63, and a temperature sensor 863 is disposed downstream of the carbon dioxide recovery pump 63. The flow rate sensor 861 measures the flow rate of the thermal medium yet to be subjected to heat exchange with the carbon dioxide recovery pump 63 and outputs the measurement result to the control device 90. The temperature sensor 862 measures the temperature of the thermal medium yet to be subjected to heat exchange with the carbon dioxide recovery pump 63 and outputs the measurement result to the control device 90. The temperature sensor 863 measures the temperature of the thermal medium subjected to heat exchange with the carbon dioxide recovery pump 63 and outputs the measurement result to the control device 90.

An instrument cooling pump 870 is disposed upstream of a branching section of the first branch line 127a and the second branch line 127b in the second instrument heat cooling line 127. In addition, a valve 318 and a valve 319 are disposed downstream of a merging section of the first branch line 127a and the second branch line 127b in the second instrument heat cooling line 127. In a case where the second intercooler 52c is disposed, the second intercooler 52c is disposed downstream of the valve 319.

The instrument cooling pump 870 according to the present embodiment is constituted by a cascade pump with sufficient head to pump the thermal medium without being hindered by high pressure loss of the vacuum pump 62 and the carbon dioxide recovery pump 63 as target instruments of heat recovery. Heat generated due to drive of the instrument cooling pump 870 as well is subjected to waste heat recovery by using the cold water.

As described above, the instrument heat recovery circuit 87 can recover waste heat of the vacuum pump 62 and the carbon dioxide recovery pump 63 to the thermal medium, thereby cooling the target instruments, and also allow the thermal medium to flow into the heat generator 81 with a high temperature potential because of the heat recovery.

Moreover, in a case where the second intercooler 52b or the second intercooler 52c is disposed, it is possible to recover water vapor condensation heat of the second intercooler 52b or the second intercooler 52c to the thermal medium and allow the thermal medium to flow into the heat generator 81 with a high temperature potential. The cold water after waste heat recovery merges into the cold water side heat source supply line 121 in which cold water discharged from the cold water tank 82 circulates, and is introduced to the heat generator 81. The cold water after waste heat recovery is heated to an appropriate temperature zone.

In the present embodiment, before entering the heat generator 81, the cold water is adjusted to a further appropriate temperature zone through the radiator bypass line 123 for cooling the cold water or the heater bypass line 124 for heating the cold water, and thus, even during operation with large thermal load fluctuations, it is possible to smooth heat fluctuations over time and stabilize the inflow temperature to the heat generator 81.

The configuration of the reservoir tank 88 will be described next. The reservoir tank 88 is a tank that can accumulate the thermal medium. The reservoir tank 88 is connected to the hot water tank 83 and also connected to the cold water tank 82. A valve 320 is disposed between the reservoir tank 88 and the hot water tank 83, and the valve 321 is disposed between the reservoir tank 88 and the cold water tank 82. When the accumulation amount of the thermal medium accumulated in the hot water tank 83 needs to be adjusted, the valve 320 is opened to transport the thermal medium between the reservoir tank 88 and the hot water tank 83. Similarly, when the accumulation amount of the thermal medium accumulated in the cold water tank 82 needs to be adjusted, the valve 321 is opened to transport the thermal medium between the reservoir tank 88 and the cold water tank 82. A level sensor 880 for measuring the accumulation amount is disposed inside the reservoir tank 88. The measurement result of the level sensor 880 is output to the control device 90. The control device 90 uses the measurement result of the level sensor 880 to determine whether the reservoir tank 88 can be used, for example.

### <Heat Exchange of High-Temperature Gas>

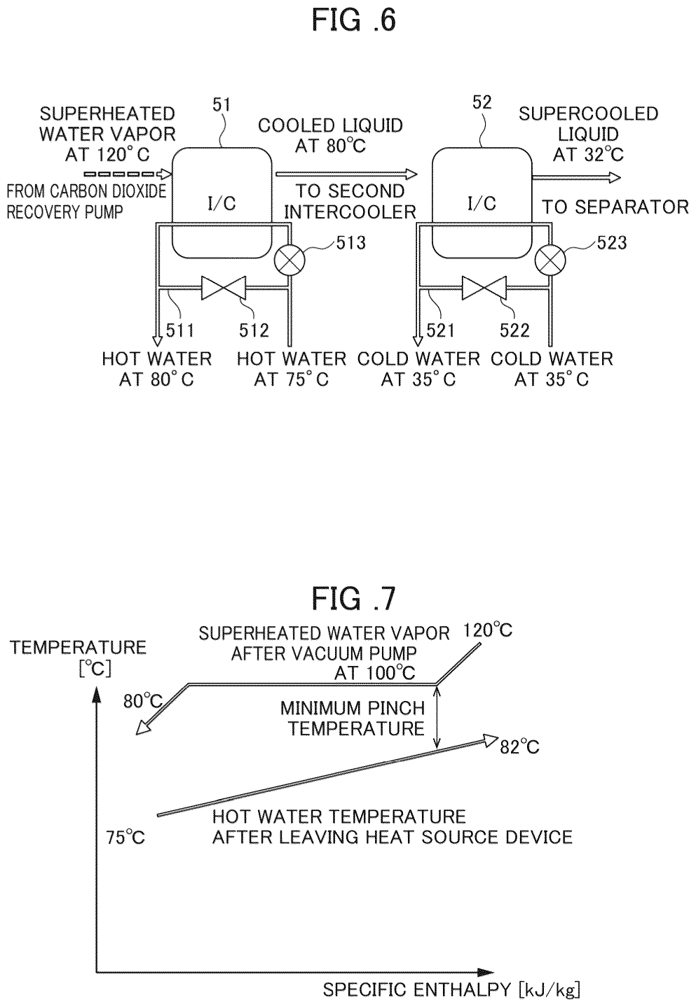

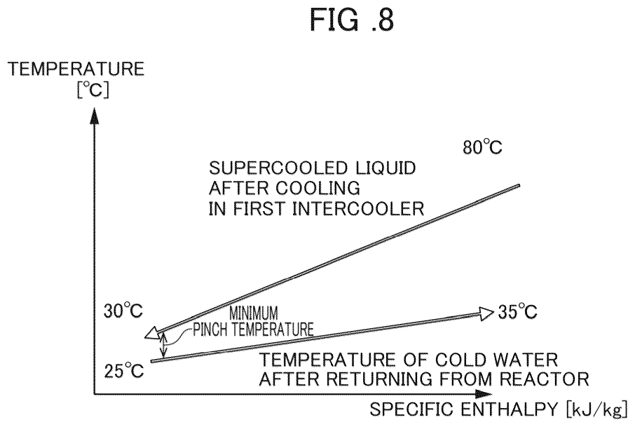

Heat exchange between superheated water vapor and hot water in the first intercooler 51 and heat exchange between supercooled liquid and cold water in the second intercooler 52 will be described next with reference to FIGS. 6 to 8. FIG. 6 is a schematic diagram of a cooling mechanism for a high-temperature gas by using the first intercooler 51 and the second intercooler 52. FIG. 7 is a graph illustrating the relation between the temperature of superheated water vapor of the high-temperature gas and the temperature of hot water, which changes through cooling by using the first intercooler 51. FIG. 8 is a graph illustrating the relation between the temperature of supercooled liquid and the temperature of cold water, which changes through cooling by using the second intercooler 52.

The first intercooler 51 is disposed at the position of the first intercooler 51a or the position of the first intercooler 51b in FIG. 5 and supplied with hot water from the heat source high-temperature water circuit 85. A high-temperature gas containing carbon dioxide and superheated water vapor is sent from the carbon dioxide recovery pump 63 to the first intercooler 51, and heat exchange is performed between the high-temperature gas and the hot water.

As illustrated in FIG. 7, the temperature of the superheated water vapor sent from the carbon dioxide recovery pump 63 decreases from 120° C. to 80° C. approximately through heat exchange with hot water heated by the heat generator 81 in the first intercooler 51 so that the superheated water vapor becomes supercooled liquid. Through the heat exchange, the specific enthalpy [kJ/kg] of the superheated water vapor gradually decreases from 120° C. and remains constant at 100° C., which is the liquefaction temperature of water, before gradually decreasing to 80° C. On the other hand, the temperature of the hot water, which serves as the counterpart in the heat exchange, is increased from 75° C. to 82° C. and the specific enthalpy [kJ/kg] of the hot water gradually increases. In the present embodiment, circuits are designed such that the temperature of the superheated water vapor exceeds the temperature of the hot water even at a minimum pinch temperature at which the temperature difference is smallest, and thus first-stage cooling, in which the first intercooler 51 cools the superheated water vapor to supercooled liquid, is appropriately performed.

The second intercooler 52 is disposed at the position of the second intercooler 52b or the position of the second intercooler 52c in FIG. 5 and supplied with cold water from the heat source low-temperature water circuit 86. Carbon dioxide and the supercooled liquid are sent from the first intercooler 51 to the second intercooler 52, and heat exchange is performed between the supercooled liquid and the cold water.

As illustrated in FIG. 8, the supercooled liquid sent from the second intercooler 52 is cooled from 80° C. to 30° C. approximately through heat exchange with cold water returning from the reactors 11 in the second intercooler 52. Through the heat exchange, the specific enthalpy [kJ/kg] of the supercooled liquid gradually decreases from 80° C. to 30° C. On the other hand, the temperature of the cold water, which serves as the counterpart in the heat exchange, is increased from 25° C. to 35° C. and the specific enthalpy [kJ/kg] of the cold water gradually increases. In the present embodiment, circuits are designed such that the temperature of the supercooled liquid exceeds the temperature of the cold water even at a minimum pinch temperature at which the temperature difference is smallest, and thus second-stage cooling, in which the second intercooler 52 cools the supercooled liquid to the room temperature of 30° C., is appropriately performed.

### <Thermal Medium Flow Rate Control>

In the present embodiment, the ratio of the flow rate (hot water amount) of hot water supplied to the first intercooler 51 and the flow rate (cold water amount) of cold water supplied to the second intercooler 52 can be adjusted. Back in FIG. 6, a configuration for adjusting the hot water amount and the cold water amount will be described below.

As illustrated in FIG. 6, the first intercooler 51 includes a first bypass line 511, a stop valve 512, and a flow rate adjustment mechanism 513. In FIG. 5, illustrations of the first bypass line 511, the stop valve 512, and the flow rate adjustment mechanism 513 are omitted.

The first bypass line 511 is a hot water flow path connecting the upstream and downstream sides of the first intercooler 51. Hot water passing through the first bypass line 511 flows to the downstream side without through the first intercooler 51.

The stop valve 512 is an opening-closing device that opens and closes the flow path of the first bypass line 511. The stop valve 512 is switched to a closed state and an opened state by the control device 90. When the stop valve 512 is controlled to the closed state, hot water undergoes heat exchange in the first intercooler 51 without flowing through the first bypass line 511. When the stop valve 512 is controlled to the opened state, hot water flows not only through the first intercooler 51 but also through the first bypass line 511.

The flow rate adjustment mechanism 513 is disposed upstream of the first intercooler 51 and downstream of a connection part to the first bypass line 511. The flow rate adjustment mechanism 513 is constituted by a mechanism capable of adjusting the amount of hot water flowing into the first intercooler 51. The flow rate adjustment mechanism 513 may have a function to close the flow path.

The second intercooler 52 includes a second bypass line 521, a stop valve 522, and a flow rate adjustment mechanism 523. In FIG. 5, illustrations of the second bypass line 521, the stop valve 522, and the flow rate adjustment mechanism 523 are omitted.

The second bypass line 521 is a cold water flow path connecting the upstream and downstream sides of the second intercooler 52. Chilled water passing through the second bypass line 521 flows to the downstream side without through the second intercooler 52.

The stop valve 522 is an opening-closing device that opens and closes the flow path of the second bypass line 521. The stop valve 522 is switched to a closed state and an opened state by the control device 90. When the stop valve 522 is controlled to the closed state, the cold water undergoes heat exchange in the second intercooler 52 without flowing through the second bypass line 521. When the stop valve 522 is controlled to the opened state, the cold water flows not only through the second intercooler 52 but also through the second bypass line 521.

The flow rate adjustment mechanism 523 is disposed upstream of the second intercooler 52 and downstream of a connection part to the second bypass line 521. The flow rate adjustment mechanism 523 is constituted by a mechanism capable of adjusting the amount of cold water flowing into the second intercooler 52. The flow rate adjustment mechanism 523 may have a function to close the flow path.

The control device 90 controls the stop valve 512 and the flow rate adjustment mechanism 513 to adjust the inflow amount of hot water to the first intercooler 51, thereby adjusting the heat recovery amount of the first intercooler 51. In addition, the control device 90 controls the stop valve 522 and the flow rate adjustment mechanism 523 to adjust the inflow amount of cold water to the second intercooler 52, thereby adjusting the heat recovery amount of the second intercooler 52. Thus, the control device 90 can stop hot water supply to the first intercooler 51 through control of the stop valve 512 and the flow rate adjustment mechanism 513 and adjust the amount of cold water to the second intercooler 52 in accordance with heat balance to be described later through control of the stop valve 522 and the flow rate adjustment mechanism 523.

### <Operation Modes>

The control device 90 according to the present embodiment has three operation modes of a cascade heat recovery mode, a low-temperature side heat recovery mode, and an auxiliary heat source operation mode. The cascade heat recovery mode or the low-temperature side heat recovery mode is selected when the heating demand of the heat generator 81 is below the recovered waste heat amount, and the auxiliary heat source operation mode is selected when the heating demand of the heat generator 81 exceeds the recovered waste heat amount. Each operation mode will be described below.

The cascade heat recovery mode is a mode in which a high-temperature gas containing carbon dioxide and superheated water vapor and sent from the carbon dioxide recovery pump 63 is cooled in the first intercooler 51 of the heat source high-temperature water circuit 85 and supercooled liquid after the cooling is cooled in the second intercooler 52 of the heat source low-temperature water circuit 86.

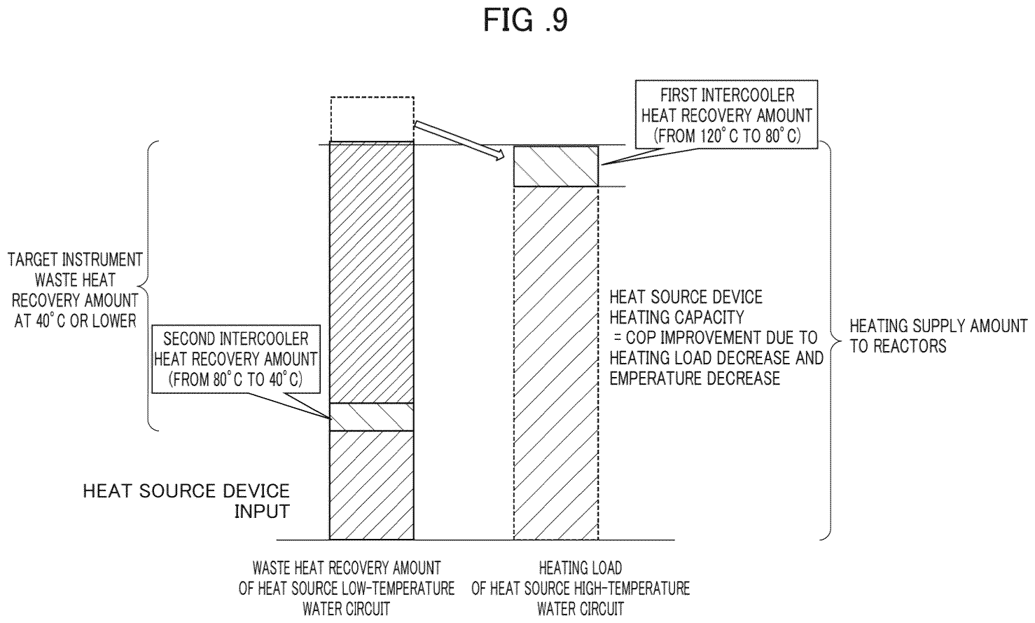

FIG. 9 is a bar graph illustrating the composition ratio of the heating load of the heat source high-temperature water circuit 85 and the composition ratio of waste heat recovery of the heat source low-temperature water circuit 86. As illustrated in FIG. 9, in the cascade heat recovery mode, the temperature of hot water is increased in the first intercooler 51 of the heat source high-temperature water circuit 85, and thus the heating amount of the heat generator 81 can be reduced relative to the amount of heating supply to the reactors 11. For example, when the temperature of hot water is increased to 82° C. only with temperature increase by the heat generator 81 without using the first intercooler 51, the condensation pressure is high and the pressure difference becomes large, and thus the necessary amount of work increases. However, in the cascade heat recovery mode, temperature increase to 75° C. can be performed by the heat generator 81, and the remaining temperature increase to 82° C. can be performed by using heat when superheated water vapor is cooled from 120° C. to 80° C. in the first intercooler 51. As in this example, when heating work by the heat generator 81 is reducing by 5° C., the heating COP improves by +7% approximately, resulting in an energy-saving effect for the heat generator 81.

Waste heat recovery of the heat source low-temperature water circuit 86 in the cascade heat recovery mode includes heat recovered from cold water input to the heat generator 81, heat recovered when supercooled liquid is cooled from 80° C. to 40° C. in the second intercooler 52, and heat recovered from the vacuum pump 62 and the carbon dioxide recovery pump 63.

The low-temperature side heat recovery mode will be described next. The low-temperature side heat recovery mode is a mode in which a high-temperature gas containing carbon dioxide and superheated water vapor and sent from the carbon dioxide recovery pump 63 is cooled in the second intercooler 52 of the heat source low-temperature water circuit 86. In the low-temperature side heat recovery mode, temperature increase of hot water in the first intercooler 51 of the heat source high-temperature water circuit 85 is not performed since the first intercooler 51 is bypassed.

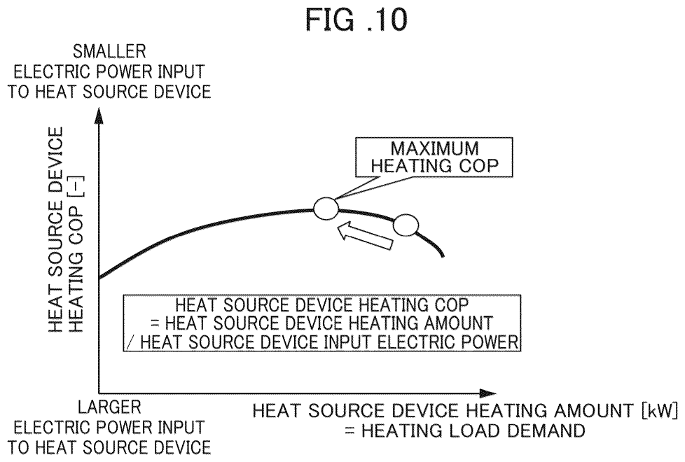

The following describes, with reference to FIG. 10, a determination criterion for selecting an energy-saving mode from among the cascade heat recovery mode and the low-temperature side heat recovery mode in a case in which the heating demand is lower than the recovered waste heat amount. FIG. 10 is a graph illustrating the relation between the heat exchange amount and heating COP of the heat generator 81. The heating COP can be calculated by, for example, dividing the heating amount of the heat generator 81 by the amount of electric power input to the heat generator 81. The heating amount of the heat generator 81 can be thought to be equal to the heating load.

The value of the heating COP of the heat generator 81 is preferably high because the power consumption amount decreases as the value increases as illustrated in FIG. 10. For the heating COP of the heat generator 81, there is a preferable heat exchange amount with which the heating COP is maximized depending on device configurations, conditions, and the like. Along with increase in the heat exchange amount, the heating COP of the heat generator 81 in the example illustrated in FIG. 9 gradually increases, is maximized at the preferable heat exchange amount, and then gradually decreases. Thus, it is possible to reduce power consumption and achieve energy saving by adjusting the heat exchange amount so that the heating COP is maximized. For example, when the heat exchange amount is larger than the heat exchange amount corresponding to the maximum heating COP, decreasing the heat exchange amount of the heat generator 81 approaches the maximum heating COP. On the other hand, when the heat exchange amount is smaller than the heat exchange amount corresponding to the maximum heating COP, increasing the heat exchange amount of the heat generator 81 approaches the maximum heating COP.

Thus, the control device 90 determines, as the energy-saving mode, a mode in which the heating COP approaches the maximum heating COP. For example, a mode in which the heat exchange amount of the heat generator 81 is reduced may be selected in a case where a heating load (heat exchange amount) larger than the heat exchange amount corresponding to the maximum heating COP is required. In this case, the cascade heat recovery mode, in which the first intercooler 51 is partially in charge of temperature increase, is selected. In a case where a heating load (heat exchange amount) smaller than the heat exchange amount corresponding to the maximum heating COP is required, it is better to increase the heat exchange amount of the heat generator 81, and thus the low-temperature side heat recovery mode is selected instead of the cascade heat recovery mode.

The auxiliary heat source operation mode is a mode in which cold water circulating through the heat source low-temperature water circuit 86 is heated by the heater 150 and then transferred to the heat generator 81. The auxiliary heat source operation mode is a mode selected in a case where the recovered waste heat amount of the heat source low-temperature water circuit 86 exceeds the heating load of the heat source high-temperature water circuit 85. The case where the recovered waste heat amount of the heat source low-temperature water circuit 86 exceeds the heating load of the heat source high-temperature water circuit 85 is, for example, a case where the temperature of cold water flowing into the heat generator 81 is lower than an activation temperature that is set to the heat generator 81.

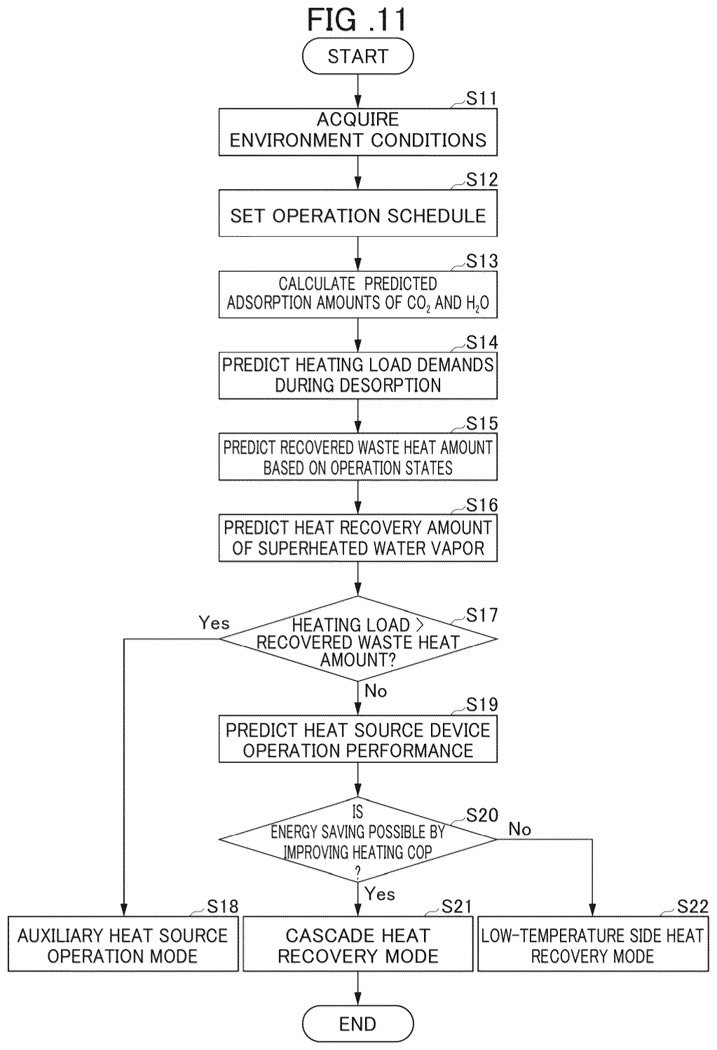

Operation control by the control device 90 will be described next. FIG. 11 is a flowchart illustrating an example of operation control processing of the carbon dioxide recovery apparatus 1 according to the present embodiment. The flowchart illustrated in FIG. 11 is an activation sequence of the carbon dioxide recovery apparatus 1.

At step S11, the control device 90 acquires external temperature (temperature), humidity (relative humidity), CO₂ concentration in the atmospheric air, which is an intake target, solar radiation, wind speed, and the like as environmental conditions. These pieces of information may be acquired based on detected values of non-illustrated various sensors or may be acquired from weather data (temperature, relative humidity, and carbon dioxide concentration) of an installation area where the carbon dioxide recovery apparatus 1 is operated, or the like.

At step S12, the control device 90 sets an operation schedule of the carbon dioxide recovery apparatus 1 based on the acquired environmental conditions.

The external temperature (temperature) and the humidity (relative humidity) acquired as the environmental conditions are used to predict a time at which the desorption process is executed in the operation schedule. The temperature and relative humidity acquired as the environmental conditions are used to predict the amount of water adsorbed onto the adsorbent 12. Specifically, in operation under a condition that the relative humidity is high, the amount of water adsorbed onto the adsorbent 12 increases, and accordingly, reaction heat for water desorption during desorption increases and the heating load increases. On the other hand, water condensation heat when passing through the first intercooler 51 and the second intercooler 52 after desorption from the adsorbent 12 is relatively large due to increase in the amount of water vapor. Thus, heating load and cooling load demands on the heat source circuit 80 side are large. The control device 90 determines whether processing is possible in a standard assumed time during desorption based on the heating capacity and cooling capacity of the heat generator 81, and determines a desorption time for achieving an appropriate desorption state.

The CO₂ concentration acquired as the environmental conditions is used to predict a time at which the adsorption process is executed in the operation schedule. With the CO₂ concentration acquired as the environmental conditions, it is possible to predict an adsorption time based on the concentration of carbon dioxide in the atmospheric air as an adsorption target by considering the concentration of carbon dioxide in the atmospheric air although the concentration of carbon dioxide in the atmospheric air has small fluctuations due to place, date, and time. The control device 90 sets the execution time of the adsorption process so that the time of the adsorption process is shorter than a standard time set in advance where the carbon dioxide concentration is high, and the time of the adsorption process is longer than the standard time where the carbon dioxide concentration is low.

The solar radiation and wind speed acquired as the environmental conditions are used together with the external temperature to calculate an energy loss generated in heating and cooling. The control device 90 calculates a loss generated at the reactors 11 and the heat source circuit 80 of the carbon dioxide recovery apparatus 1 based on the solar radiation, the wind speed, and the external temperature. The loss calculation may be performed by using machine learning or the like based on formulae, tables, and the like set based on the operation record of the carbon dioxide recovery apparatus 1, past experiment data, and the like. The calculated loss is reflected onto the execution times of the adsorption process and the desorption process, which makes it possible to more accurately calculate the execution times of the adsorption process and the desorption process.

With a configuration in which a plurality of reactors 11 are operated in rotation like the carbon dioxide recovery apparatus 1 according to the present embodiment, the execution time of the adsorption process and the execution time of the desorption process affect the adsorption amount of carbon dioxide in an operation time. The adsorption amount of carbon dioxide in the operation time can be maximized by accurately calculating the execution time of the adsorption process and the execution time of the desorption process based on the environmental conditions acquired in advance and determining the operation schedule. The control device 90 sets, as the operation schedule, the ratio of the adsorption and desorption times, the execution timing of each process in each reactor 11, and the like.

At step S13, the control device 90 calculates the adsorption amounts of carbon dioxide and water adsorbed onto the adsorbent 12 based on the set operation schedule. The adsorption amount of carbon dioxide can be calculated by using “density×air volume×(concentration after adsorption−concentration before adsorption)”. The difference between the concentrations before and after adsorption can be acquired in real time by the carbon dioxide sensor 26. The adsorption amount of water can be calculated by using “density×air volume×(air absolute humidity before adsorption-absolute humidity after adsorption)”. The air volume may be acquired as the environmental conditions.

At step S14, the control device 90 predicts heating load demands for reactors 11 during execution of the desorption process. The control device 90 predicts heating load demands during execution of the desorption process based on the sum of the heating loads of reactors 11 simultaneously executing the desorption process on the operation schedule. In the present embodiment, the desorption process is simultaneously executed in four reactors 11, and thus heating load demands are predicted and calculated based on the sum of the heating loads of the four reactors 11.

An exemplary method of calculating a heating load per reactor 11 will be described below. A heating time in the desorption process is determined by the operation schedule. The heating load (amount of heat required for heating) during the heating time per reactor 11 can be calculated based on “reactor thermal mass+reaction heat+heat loss”. The “reactor thermal mass” can be obtained in advance from, for example, the amount of the adsorbent 12, the mass and specific heat of a non-illustrated heat exchanger in which the adsorbent 12 is disposed inside the reactor 11, and the mass and specific heat of any other component in the reactor 11. The “reaction heat” in the desorption process is determined by the adsorption amount of carbon dioxide and the adsorption amount of water adsorbed by the reactor 11. The control device 90 calculates the “reaction heat” based on the adsorption amount of carbon dioxide and the adsorption amount of water, which are calculated in the processing at step S13. The “heat loss” can be determined by the difference between the external temperature and the temperature of the reactor 11. The control device 90 calculates the “heat loss” by using the external temperature acquired at step S11 and a temperature detected by the temperature sensor 27.

At step S15, the control device 90 predicts the recovered waste heat amount based on the operation states (cooling demands) of target instruments such as the first intercooler 51, the second intercooler 52, the vacuum pump 62, and the carbon dioxide recovery pump 63 and the operation states (cooling demands) of the reactors 11 in the carbon dioxide recovery apparatus 1.

The recovered waste heat amount can be calculated based on “heat recovery during precooling after desorption in the reactor 11+heat recovery during water vapor condensation in the first intercooler 51 and the second intercooler 52+heat recovery during cooling of the vacuum pump 62 and the carbon dioxide recovery pump 63+heat recovery from other pumps and the like−heat loss generated in circuits”. The “heat recovery during precooling after desorption in the reactor 11” can be calculated by multiplying the difference from desorption temperature to cooling temperature by the reactor thermal mass. For example, in a case where precooling is performed to the room temperature of 30° C. with the desorption temperature of 80° C., the “heat recovery during precooling after desorption in the reactor 11” can be calculated by 50° C. (ΔT)×the reactor thermal mass. Since the water adsorption amount in a reactor 11 that executes the adsorption process can be obtained, the “heat recovery during water vapor condensation in the first intercooler 51 and the second intercooler 52” can be calculated by predicting a water vapor condensation heat amount necessary for condensation after the desorption process based on the water adsorption amount. The “heat recovery during cooling of the vacuum pump 62 and the carbon dioxide recovery pump 63” can be calculated based on the difference between the inflow side and the outflow side in the temperature of the cooling thermal medium supplied to the vacuum pump 62 and the carbon dioxide recovery pump 63 for cooling. The “heat recovery from other pumps and the like” can be calculated based on the difference between the inflow side and the outflow side in the temperature of the cooling thermal medium supplied to each instrument. The other pumps are, for example, the cold water side circulation water pump 821, the first cold water circulation water pump 822, the second cold water circulation water pump 823, the hot water side circulation water pump 831, the first hot water circulation water pump 832, and the second hot water circulation water pump 833. The “heat loss generated in circuits” can be determined by referring to a map, a table, a formula, or the like set in advance based on the relation between the external temperature and an average pipe temperature.

At step S16, the control device 90 predicts the heat recovery amount of superheated water vapor sent from the carbon dioxide recovery pump 63. The heat recovery amount of superheated water vapor can be calculated based on the water vapor condensation heat amount of the first intercooler 51 and the second intercooler 52. As described above in the processing at step S15, the water vapor condensation heat amount can be calculated based on the sum of superimposed water adsorption amounts during the adsorption process in reactors 11 simultaneously executing the adsorption process.

At step S17, the control device 90 determines whether the heating demand exceeds the recovered waste heat amount to take into consideration the heat balance between the heating demand and the recovered waste heat amount. The control device 90 advances processing to step S18 in a case where the heating demand exceeds the recovered waste heat amount (Yes at step S17), or advances processing to step S19 in a case where the heating demand does not exceed the recovered waste heat amount (No at step S17).

At step S18, since the recovered waste heat amount exceeds the heating demand, the control device 90 executes the auxiliary heat source operation mode in which the heater 150 is activated to heat the cold water. In the auxiliary heat source operation mode, the cold water is heated by the heater 150 to ensure the recovered waste heat amount of the heat source low-temperature water circuit 86.

At step S19, the control device 90 predicts operation performance based on cold water inflow temperature and hot water inflow temperature of the heat generator 81. In the present embodiment, the control device 90 acquires the cold water inflow temperature of the heat generator 81 from the temperature sensor 132, acquires the hot water inflow temperature of the heat generator 81 from the temperature sensor 232, and calculates a heating COP (coefficient of performance) representing operation performance based on the temperature difference between the cold water inflow temperature and the hot water inflow temperature. The heating COP can be calculated by “heating load/heat generator power consumption”. The “heating load” can be calculated by processing at step S15. The “heat generator power consumption” is the power consumption of the heat generator 81 and determined by the relation between a temperature generated by the heat source to be supplied to the heating side and a heating load amount, and the relation between the temperature of cold water flowing into the heat generator based on prediction of waste heat recovery on the cooling side and the recovered waste heat amount. The relations can be acquired by setting a map, a table, or a formula of the heating COP on the heat generator 81 side in advance.

At step S20, the control device 90 selects the energy-saving mode from among the cascade heat recovery mode and the low-temperature side heat recovery mode based on the heating COP. In a case where the energy-saving mode is the cascade heat recovery mode (Yes at step S20), the control device 90 advances processing to step S21 and executes the cascade heat recovery mode at step S21. In a case where energy saving is impossible (No at step S20), the control device 90 advances processing to step S22 and executes the low-temperature side heat recovery mode at step S22.

In this manner, the control device 90 controls each of the heat source high-temperature water circuit 85 and the heat source low-temperature water circuit 86 based on the selected operation mode.

Moreover, the control device 90 may adjust the ratio of the heat recovery amount of heat recovery in the first intercooler 51 and the heat recovery amount of heat recovery in the second intercooler 52. The heat recovery amount of heat recovery in the first intercooler 51 can be controlled by, for example, adjusting the flow rate of hot water. The heat recovery amount of heat recovery in the second intercooler 52 can be controlled by, for example, adjusting the flow rate of cold water. Thus, the heating amount can be adjusted to approach a maximum COP set to the heat generator 81.

As described above, the carbon dioxide recovery apparatus 1 according to the present embodiment includes: a reactor 11 that includes the adsorbent 12 inside and executes the adsorption process in which a gas containing carbon dioxide is drawn toward the adsorbent 12 to adsorb the carbon dioxide and the desorption process in which the adsorbent 12 is heated under surrounding reduced pressure to desorb the carbon dioxide from the adsorbent 12; the heat exchanger 70 capable of executing heating that supplies hot water (heating thermal medium) to the reactor 11 and cooling that supplies cold water (cooling thermal medium) to the reactor 11; the first intercooler (first cooler) 51 that cools a gas containing the carbon dioxide desorbed in the desorption process and water vapor; and the second intercooler (second cooler) 52 that cools a gas containing the carbon dioxide desorbed in the desorption process and water vapor, and the heat exchanger 70 includes the heat-pump heat generator 81 that heats the hot water and cools the cold water, the heat source high-temperature water circuit 85 in which the hot water used to heat the reactor 11 is heated by the heat generator 81 and waste heat is recovered from the first intercooler 51 by using the hot water, and the heat source low-temperature water circuit 86 in which the cold water used to cool the reactor 11 is cooled by the heat generator 81 and waste heat is recovered from the second intercooler 52 by using the cold water.

Moreover, a carbon dioxide recovery method according to the present embodiment includes: heating the hot water and cooling the cold water by the heat-pump heat generator 81 included in the heat exchanger 70; heating the hot water used to heat the reactor 11 by the heat generator 81 and recovering waste heat from the first intercooler 51 by using the hot water; and cooling the cold water used to cool the reactor 11 by the heat generator 81 and recovering waste heat from the second intercooler 52 by using the cold water.

With the carbon dioxide recovery apparatus 1 and the carbon dioxide recovery method thus configured, the hot water can be heated in the heat source high-temperature water circuit 85 by using heat used to cool superheated water vapor in the first intercooler 51. The temperature of the cold water flowing into the heat generator 81 can be increased in the heat source low-temperature water circuit 86 by using heat used to cool supercooled liquid in the second intercooler 52, thereby improving COP. The energy-efficiency carbon dioxide recovery apparatus 1 utilizing cooling of a high-temperature gas containing carbon dioxide and superheated water vapor can be achieved.

Moreover, the carbon dioxide recovery apparatus 1 according to the present embodiment further includes the control device 90 that controls the flow rate of the hot water flowing to the first intercooler 51 and the flow rate of the cold water flowing to the second intercooler 52 based on the balance between a heating load applied to the heat source high-temperature water circuit 85 and the recovered waste heat amount in the heat source low-temperature water circuit 86.

With this configuration, heat exchange of the first intercooler 51 and the second intercooler 52 can be controlled by the control device 90 in accordance with the balance between the heating load during operation and the recovered waste heat amount, which makes it possible to achieve energy-efficiency operation of the carbon dioxide recovery apparatus 1 in accordance with environmental conditions and operating conditions.

Moreover, in the present embodiment, the control device 90 calculates the recovery amounts of the carbon dioxide and water based on environmental conditions of external air, calculates the heating load based on predicted recovery amounts of the carbon dioxide and the water, calculates the recovered waste heat amount of the heat source low-temperature water circuit 86 based on the cooling demand of a target instrument that executes the adsorption process or the desorption process or the cooling demand of the reactor 11, predicts the heating COP of the heat generator 81 during operation based on the temperatures of the hot water and the cold water that are supplied to the heat generator 81 and the heating load, and selects the cascade heat recovery mode (first heat recovery mode) in which waste heat is recovered in each of the first intercooler 51 and the second intercooler 52 in a case where the heating COP can be improved, or selects the low-temperature side heat recovery mode (second heat recovery mode) in which waste heat is recovered in the second intercooler 52 in a case where the heating COP cannot be improved even by selecting the cascade heat recovery mode.

With this configuration, an appropriate mode is selected from the perspective of energy efficiency based on environmental conditions such as the temperature-humidity state of intake air from among the cascade heat recovery mode in which waste heat is recovered in both the first intercooler 51 and the second intercooler 52 and the low-temperature side heat recovery mode in which waste heat is recovered in the second intercooler 52. For example, in a situation where the waste heat amount of the second intercooler 52 in the heat source low-temperature water circuit 86 increases and waste heat cannot be effectively utilized, the cascade heat recovery mode is selected and waste heat recovery in the first intercooler 51 in the heat source high-temperature water circuit 85 is performed together with waste heat recovery in the second intercooler 52. Accordingly, overflow of waste heat recovery on the heat source low-temperature water circuit 86 side is avoided, and waste heat recovery in the first intercooler 51 can be utilized to increase the temperature of the hot water, which leads to improvement in COP by decreasing the heating amount of the heat generator 81.

Moreover, in the present embodiment, in the cascade heat recovery mode, the amount and temperature of heat recovery in the heat source high-temperature water circuit 85 control at least one selected from the flow rate of the hot water flowing to the first intercooler 51 and the flow rate of the cold water flowing to the second intercooler 52 so that the heating COP of the heat generator 81 is maximized.

With this configuration, it is possible to more accurately achieve the balance between the heating load and waste heat recovery, thereby further improving energy efficiency of the carbon dioxide recovery apparatus 1.

Moreover, in the present embodiment, the second intercooler 52 cools a gas cooled by the first intercooler 51.

With this configuration, it is possible to increase the temperature of the hot water in the heat source high-temperature water circuit 85 by utilizing heat of high-temperature superheated water vapor cooled by the first intercooler 51, and increase the temperature of the cold water by utilizing heat when supercooled liquid after the cooling in the first intercooler 51 is cooled by the second intercooler 52. It is possible to achieve efficient heating and cooling in accordance with each necessary temperature zone.

Moreover, in the present embodiment, the heat source high-temperature water circuit 85 includes the hot water tank (heating thermal medium tank) 83 that accumulates the hot water, the hot water side heat source supply line (heating thermal medium side heat source supply line) 221 that transfers the hot water from the hot water tank 83 to the heat generator 81, and the hot water side heat source return line (heating thermal medium side heat source return line) 222 that returns the hot water from the heat generator 81 to the hot water tank 83. The first intercooler 51a is disposed in the hot water supply line (heating thermal medium supply line) 112a that supplies the hot water from the hot water tank 83 to the reactor 11, or the first intercooler 51b is disposed in the hot water side heat source return line (heating thermal medium side heat source return line) 222.

The first intercooler 51a is disposed in the hot water supply line 112a, and thus in a case where the temperature of the hot water supplied to the reactor 11 needs to be increased to 80° C., heating can be performed by the heat generator 81 so that the temperature of the hot water accumulated in the hot water tank 83 is maintained at 75° C. approximately, and then temperature increase can be performed by the first intercooler 51a from 75° C. to 80° C. Accordingly, COP is high and heating of the first intercooler 51a is performed on the reactor 11 side, and thus a heat-releasing loss can be reduced. Moreover, since the first intercooler 51b is disposed in the hot water side heat source return line 222, the upper limit of temperature increase of the heat generator 81 can be lowered from 80° C. to 75° C. and the temperature of the hot water from the heat generator 81 toward the hot water tank 83 can be increased to the vicinity of 80° C. in the first intercooler 51b and the hot water is accumulated in the hot water tank 83. Load fluctuations of the heat generator 81 due to fluctuations in the recovered waste heat amount on the low-temperature side can be absorbed by the hot water tank 83 so that the hot water at a constant temperature can be supplied to the reactor 11.

Moreover, in the present embodiment, the heat source low-temperature water circuit 86 includes the cold water tank (cooling thermal medium tank) 82 that accumulates the cold water, the cold water side heat source supply line (cooling thermal medium side heat source supply line) 121 that transfers the cold water from the cold water tank 82 to the heat generator 81, the cold water side heat source return line (cooling thermal medium side heat source return line) 122 that returns the cold water from the heat generator 81 to the cold water tank 82, and the instrument heat recovery circuit 87 that branches from the heat source low-temperature water circuit 86, is connected to the inflow side of the heat source low-temperature water circuit 86 to the heat generator 81 through a target instrument (the vacuum pump 62, the carbon dioxide recovery pump 63, or the second intercooler 52) for performing the adsorption process or the desorption process, and returns the cold water used to recover waste heat from the target instrument to the heat generator 81. The second intercooler 52a is disposed in the cold water return line (cooling thermal medium return line) 111b that returns the cold water from the reactor 11 to the cold water tank 82, or the second intercooler 52b is disposed as the target instrument in the instrument heat recovery circuit 87.

Since the second intercooler 52a is disposed in the cold water return line 111b, the cold water undergoes temperature increase before returning to the cold water tank 82 so that the temperature of the cold water accumulated in the cold water tank 82 can be increased. Accordingly, high-potential cold water (low temperature waste heat) can be supplied to the low-temperature side of the heat generator 81, which makes it possible to reduce temperature difference from the high-temperature side, thereby improving COP. Moreover, since the second intercooler 52b is disposed in the instrument heat recovery circuit 87, lowest-temperature cooling water cooled by the heat generator 81 can be supplied to the second intercooler 52b, which allows for a large temperature difference, and thus the second intercooler 52b can be downsized.

Moreover, in the present embodiment, the target instrument is the vacuum pump 62 or the carbon dioxide recovery pump 63 that applies suction force to the reactor 11, and the second intercooler 52 is disposed downstream of the vacuum pump 62 or the carbon dioxide recovery pump 63 in the instrument heat recovery circuit 87.

With this configuration, after the temperature of the cold water is increased through heat exchange in the vacuum pump 62 or the carbon dioxide recovery pump 63, the temperature of the cold water can be further increased through heat exchange in the second intercooler 52, and high-quality low-temperature waste heat can be supplied to the low-temperature side of the heat generator 81.

Although the configuration in which the first intercooler 51 and the second intercooler 52 are disposed in series in the flow path of carbon dioxide and superheated water vapor is described above in the embodiment, the present invention is not limited to the configuration.

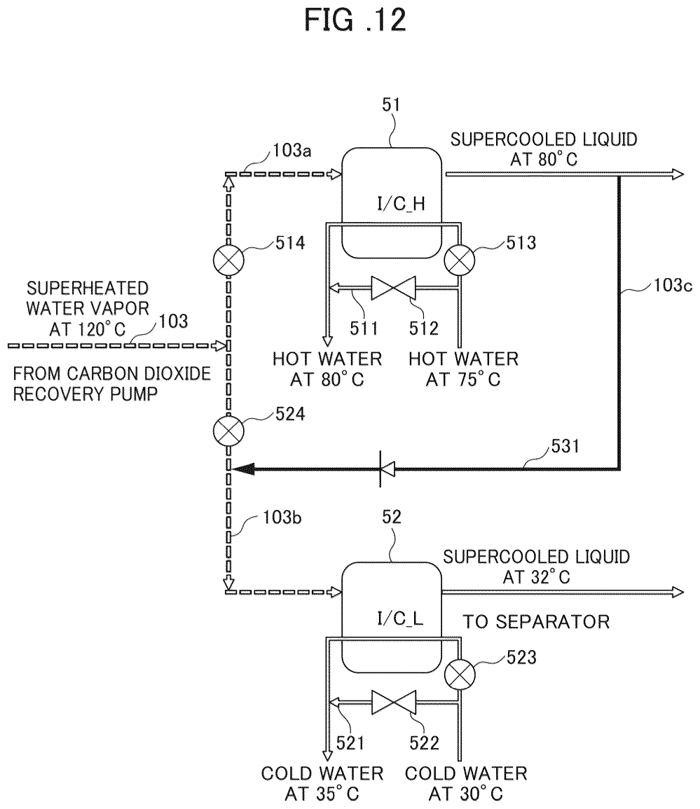

A modification in which the disposition relation between the first intercooler 51 and the second intercooler 52 is different will be described below with reference to FIG. 12. FIG. 12 is a schematic diagram of a cooling mechanism for a high-temperature gas by using the first intercooler 51 and the second intercooler 52 according to the modification. In the following description, any component common or similar to that in the above-described embodiment is denoted by the same reference sign, and detailed description thereof is omitted in some cases.

As illustrated in FIG. 12, the carbon dioxide line 103 according to the modification includes a first carbon dioxide line 103a, a second carbon dioxide line 103b, and a third carbon dioxide line 103c.

The first carbon dioxide line 103a is connected to the first intercooler 51. A flow rate adjustment mechanism 514 is disposed in the first carbon dioxide line 103a. The flow rate adjustment mechanism 514 includes a mechanism that adjusts the flow rate of a gas containing carbon dioxide and superheated water vapor and flowing into the first intercooler 51 through the first carbon dioxide line 103a.

The second carbon dioxide line 103b is connected to the second intercooler 52. A flow rate adjustment mechanism 524 is disposed in the second carbon dioxide line 103b. The flow rate adjustment mechanism 524 includes a mechanism that adjusts the flow rate of a gas containing carbon dioxide and superheated water vapor and flowing into the second intercooler 52 through the second carbon dioxide line 103b.

The third carbon dioxide line 103c is a bypass flow path that returns carbon dioxide and water cooled in the first intercooler 51 to the downstream side of the flow rate adjustment mechanism 524 in the second carbon dioxide line 103b. A check valve 531 is disposed in the third carbon dioxide line 103c to prevent movement of carbon dioxide and water from the second carbon dioxide line 103b side to the third carbon dioxide line 103c side. Carbon dioxide and water cooled in the first intercooler 51 is cooled in the second intercooler 52, as well, through the third carbon dioxide line 103c.

The control device 90 can adjust the amount of gas flowing into the first intercooler 51 and the amount of gas flowing into the second intercooler 52 by controlling the flow rate adjustment mechanism 514 and the flow rate adjustment mechanism 524. Moreover, the control device 90 can adjust the heat recovery amount of the first intercooler 51 by controlling the stop valve 512 and the flow rate adjustment mechanism 513 and can adjust the heat recovery amount of the second intercooler 52 by controlling the stop valve 522 and the flow rate adjustment mechanism 523.

In the present modification, in a case where the control device 90 controls the flow rate adjustment mechanism 514 and the flow rate adjustment mechanism 524 so that a gas containing carbon dioxide and superheated water vapor flows in parallel to the first intercooler 51 and the second intercooler 52, a mixture of superheated water vapor supplied from the carbon dioxide recovery pump 63 through the second carbon dioxide line 103b and supercooled liquid after cooled in the first intercooler 51 is supplied to the second intercooler 52. With the configuration of the present modification, the amount of heat supplied to the second intercooler 52 is larger than with the series configuration illustrated in FIG. 6 in the above-described embodiment, and thus the configuration of the present modification is particularly effective in a case of a high heat recovery demand for the second intercooler 52 on the low-temperature side due to the thermal load balance.

In this manner, a mechanism that cools carbon dioxide and superheated water vapor can be changed as appropriate in accordance with situations.

Although the embodiment of the present invention is described above, the present invention is not limited to the above-described embodiment and modification. Moreover, the effects described in the above embodiment are merely examples of preferable effects, and the present invention is not limited to those described in the above embodiment.

### EXPLANATION OF REFERENCE NUMERALS

1 carbon dioxide recovery apparatus
11 reactor
12 adsorbent
51 first intercooler (first cooler)
52 second intercooler (second cooler)
62 vacuum pump
63 carbon dioxide recovery pump
70 heat exchanger
80 heat source circuit
81 heat generator
82 cold water tank (cooling thermal medium tank)
83 hot water tank (heating thermal medium tank)
85 heat source high-temperature water circuit
86 heat source low-temperature water circuit
87 instrument heat recovery circuit
90 control device
111 cold water line (cooling thermal medium line)
111a cold water supply line (cooling thermal medium supply line)
111b cold water return line (cooling thermal medium return line)
112 hot water line (heating thermal medium line)
112a hot water supply line (heating thermal medium supply line)
112b hot water return line (heating thermal medium return line)
150 heater

What is claimed is:

1. A carbon dioxide recovery apparatus comprising:
a reactor that includes an adsorbent inside and executes an adsorption process in which a gas containing carbon dioxide is drawn toward the adsorbent to adsorb the carbon dioxide and a desorption process in which the adsorbent is heated under surrounding reduced pressure to desorb the carbon dioxide from the adsorbent;
a heat exchanger capable of executing heating that supplies a heating thermal medium to the reactor and cooling that supplies a cooling thermal medium to the reactor;
a first cooler that cools a gas containing the carbon dioxide desorbed in the desorption process and water vapor; and
a second cooler that cools the gas containing the carbon dioxide desorbed in the desorption process and water vapor,
wherein the heat exchanger includes
a heat-pump heat generator that heats the heating thermal medium and cools the cooling thermal medium,
a heat source high-temperature water circuit in which the heating thermal medium used to heat the reactor is heated by the heat generator and waste heat is recovered from the first cooler by using the heating thermal medium, and
a heat source low-temperature water circuit in which the cooling thermal medium used to cool the reactor is cooled by the heat generator and waste heat is recovered from the second cooler by using the cooling thermal medium.

2. The carbon dioxide recovery apparatus according to claim 1, further comprising a control device that controls a flow rate of the heating thermal medium flowing to the first cooler, and a flow rate of the cooling thermal medium flowing to the second cooler based on a balance between a heating load applied to the heat source high-temperature water circuit and a recovered waste heat amount in the heat source low-temperature water circuit.

3. The carbon dioxide recovery apparatus according to claim 2, wherein the control device
calculates recovery amounts of the carbon dioxide and water based on environmental conditions of external air,
calculates the heating load based on predicted recovery amounts of the carbon dioxide and the water,
calculates the recovered waste heat amount of the heat source low-temperature water circuit based on a cooling demand of a target instrument that executes the adsorption process or the desorption process or a cooling demand of the reactor,
predicts a heating COP of the heat generator during operation based on temperatures of the heating thermal medium and the cooling thermal medium that are supplied to the heat generator, and the heating load, and
selects a first heat recovery mode in which waste heat is recovered in each of the first cooler and the second cooler in a case where the heating COP can be improved, or selects a second heat recovery mode in which waste heat is recovered in the second cooler in a case where the heating COP cannot be improved even by selecting the first heat recovery mode.

4. The carbon dioxide recovery apparatus according to claim 3, wherein in the first heat recovery mode, an amount and temperature of heat recovery in the heat source high-temperature water circuit control at least one selected from the flow rate of the heating thermal medium flowing to the first cooler and the flow rate of the cooling thermal medium flowing to the second cooler so that the heating COP of the heat generator is maximized.

5. The carbon dioxide recovery apparatus according to claim 1, wherein the second cooler cools a gas cooled by the first cooler.

6. The carbon dioxide recovery apparatus according to claim 1, wherein
the heat source high-temperature water circuit includes
a heating thermal medium tank that accumulates the heating thermal medium,
a heating thermal medium side heat source supply line that transfers the heating thermal medium from the heating thermal medium tank to the heat generator, and
a heating thermal medium side heat source return line that returns the heating thermal medium from the heat generator to the heating thermal medium tank, and
the first cooler is disposed in a heating thermal medium supply line that supplies the heating thermal medium from the heating thermal medium tank to the reactor or in the heating thermal medium side heat source return line.

7. The carbon dioxide recovery apparatus according to claim 1, wherein
the heat source low-temperature water circuit includes
a cooling thermal medium tank that accumulates the cooling thermal medium,
a cooling thermal medium side heat source supply line that transfers the cooling thermal medium from the cooling thermal medium tank to the heat generator,
a cooling thermal medium side heat source return line that returns the cooling thermal medium from the heat generator to the cooling thermal medium tank, and
an instrument heat recovery circuit that branches from the heat source low-temperature water circuit, is connected to an inflow side of the heat source low-temperature water circuit to the heat generator through a target instrument for performing the adsorption process or the desorption process, and returns the cooling thermal medium used to recover waste heat from the target instrument to the heat generator, and
the second cooler is disposed in a cooling thermal medium return line that returns the cooling thermal medium from the reactor to the cooling thermal medium tank or is disposed as the target instrument in the instrument heat recovery circuit.

8. The carbon dioxide recovery apparatus according to claim 7, wherein
the target instrument is a pump that applies suction force to the reactor, and
the second cooler is disposed downstream of the pump in the instrument heat recovery circuit.

9. A carbon dioxide recovery method using a carbon dioxide recovery apparatus comprising:
a reactor that includes an adsorbent inside and executes an adsorption process in which a gas containing carbon dioxide is drawn toward the adsorbent to adsorb the carbon dioxide and a desorption process in which the adsorbent is heated under surrounding reduced pressure to desorb the carbon dioxide from the adsorbent;
a heat exchanger capable of executing heating that supplies a heating thermal medium to the reactor and cooling that supplies a cooling thermal medium to the reactor;
a first cooler that cools a gas containing the carbon dioxide desorbed in the desorption process and water vapor; and
a second cooler that cools the gas containing the carbon dioxide desorbed in the desorption process and water vapor,
the carbon dioxide recovery method comprising:
heating the heating thermal medium and cooling the cooling thermal medium by a heat-pump heat generator included in the heat exchanger;
heating the heating thermal medium used to heat the reactor by the heat generator and recovering waste heat from the first cooler by using the heating thermal medium; and
cooling the cooling thermal medium used to cool the reactor by the heat generator and recovering waste heat from the second cooler by using the cooling thermal medium.
